(19) United States
(12) Patent Application Publication
(10) Pub. No.: US 2007/0037894 A1
(43) Pub. Date: Feb. 15, 2007

(54) Multifunctional menomers and polyarylene compsotions therefrom

(76) Inventors: Jerry L. Hahnfeld, Midland, MI (US); Youngfu Li, Midland, MI (US); Q. Jason Niu, Excelsior, MN (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/571,810

(22) PCT Filed: Sep. 15, 2004
(86) PCT No.: PCT/US04/30227

§ 371 Date: Mar. 15, 2006

Related U.S. Application Data
(60) Provisional application No. 60/504,562, filed on Sep. 19, 2003.

(51) Int. Cl. C08J 9/26

(52) U.S. Cl. 521/61

(57) ABSTRACT

A compound comprising i) one or more dienophile groups (A-functional groups), ii) one or more ring structures comprising two conjugated carbon-to-carbon double bonds and a leaving group L (B-functional groups), and iii) one or more addition polymerizable, telechelic, or graftable functional groups, excluding groups capable of cycloaddition reactions with acetylenic- or conjugated diene functionality (C′-functional groups), characterized in that the A-functional group of one monomer is capable of reaction under cycloaddition reaction conditions with the B-functional group of a second monomer to thereby form a polymer.

### FIELD OF THE INVENTION

This invention relates to compositions having at least three different reactive functional groups and to aromatic polymers made from these monomers. More particularly, the invention relates to compositions comprising in a single monomer polyphenylene matrix forming functionality and addition-, telechelic- or graft-polymerizable reactive functionality. The resulting polymers are useful in making low dielectric constant insulating layers in microelectronic devices.

### BACKGROUND OF THE INVENTION

Polyarylene resins, such as those disclosed in U.S. Pat. No. 5,965,679 (Godschalx et al.) are low dielectric constant materials suitable for use as insulating films in semiconductor devices, especially integrated circuits. Such polyarylene compounds are prepared by reacting polyfunctional compounds having two or more cyclopentadienone groups with polyfunctional compounds having two or more aromatic acetylene groups, at least some of the polyfunctional compounds having three or more reactive groups. Certain single component reactive monomers which contained one cyclopentadienone group together with two aromatic acetylene groups, specifically 3,4-bis(3-(phenylethynyl)phenyl)-2,5-dicyclopentadienone and 3,4-bis(4-(phenylethynyl)phenyl)-2,5-dicyclopentadienone, and polymers made from such monomers were also disclosed in the foregoing reference. Typically, these materials are b-staged in a solution and then coated onto a substrate followed by curing (vitrification) at elevated temperatures as high as 400-450° C. to complete the cure.

In U.S. Pat. No. 6,359,091, it was taught that it may be desirable to adjust the modulus of polymers as taught in Godschalx et al., by adjusting the ratio of the reactants or by adding other reactive species to the monomers or to the partially polymerized product of Godschalx et al. U.S. Pat. No. 6,172,128 teaches aromatic polymers containing cyclopentadienone groups that may react with aromatic polymers containing phenylacetylene groups to provide branched or cross-linked polymers. U.S. Pat. No. 6,156,812 discloses polymers which contain both cyclopentadienone- and phenyl acetylene-backbone groups.

In WO 00/31183, cross-linkable compositions comprising a cross-linkable hydrocarbon-containing matrix precursor and a separate pore forming substance (poragen) which are curable to form low dielectric constant insulating layers for semiconductor devices were disclosed. By partially curing the precursor to form a matrix containing occlusions of the poragen and then removing the pore generating material to form voids or pores in the matrix material, lower dielectric constant insulating films may be prepared. It has now been discovered that the use of mixtures of a curable matrix resin and a separately added pore forming material, especially an ultra-small sized poragen, to form a b-staged polyphenylene resin formulation can suffer from poragen agglomeration, resulting in large diameter pore formation and an inhomogeneous distribution of pores, leading to variation in the electronic properties of the resulting film.

Although the foregoing advances have led to improvements in dielectric constant of the resulting film, additional improvements in film properties are desired by the industry. In particular, films and other cured compositions having improved physical properties, especially uniformly distributed, small pores, are sought.

### SUMMARY OF THE INVENTION

According to a first embodiment of the present invention there is provided a compound (monomer) comprising i) one or more dienophile groups (A-functional groups), ii) one or more ring structures comprising two conjugated carbon-to-carbon double bonds and a leaving group L (B-functional groups), and iii) one or more addition polymerizable, telechelic, or graftable functional groups, excluding groups capable of cycloaddition reactions with acetylenic- or conjugated diene-functionality (C′-functional groups), characterized in that the A-functional group of one monomer is capable of reaction under cycloaddition reaction conditions with the B-functional group of a second monomer to thereby form a cross-linked, polyphenylene polymer.

According to a second embodiment of this invention, there is provided a curable oligomer or polymer made by the partial reaction of the A and B groups of the foregoing monomer, a mixture thereof, or a composition comprising the same under cycloaddition reaction conditions. In this embodiment of the invention the curable oligomer or polymer comprises some remainder of the two reactive A and B functional groups as pendant groups, terminal groups, or as groups within the backbone of the oligomer or polymer, with or without polymerization or grafting of C′ groups.

According to a third embodiment of the invention, C′ groups on the monomer or on the curable oligomer or polymer of the second embodiment are reacted with one or more addition polymerizable monomers, telegens or graft polymerizable monomers or polymers, thereby incorporating bound poragen moieties into said monomer, oligomer or polymer.

According to a fourth embodiment of the invention, residual C′ groups on the monomer or on the curable oligomer or polymer of the second or third embodiment are reacted with one another, optionally in the presence of one or more addition polymerizable monomers, telegens or graft polymerizable monomers, thereby forming a partially cross-linked matrix, optionally containing bound poragen moieties.

According to a fifth embodiment this invention is a crosslinked polymer made by curing and crosslinking the foregoing curable monomers or oligomers of the first through third embodiments, or polymers or compositions comprising the same. Desirably, if bound poragens are present in the monomers or oligomers, the resulting cross-linked polymer contains bound poragens that are homogeneously distributed throughout the polymer.

According to a sixth embodiment of the invention there is provided a process for making a porous, solid article comprising a vitrified polyarylene polymer which process comprises providing the foregoing curable monomers or oligomers of the first through third embodiments, or polymers or compositions comprising the same; partially polymerizing the monomer under cycloaddition reaction conditions optionally in the presence of a solvent, one or more addition polymerizable monomers, telegens or graft polymerizable monomers, and/or one or more separately added poragens, thereby forming a curable oligomer or polymer containing composition; and curing and crosslinking the composition to form a solid polyarylene polymer containing bound porogens and optionally separately added poragens. In a further step, the optional solvent, bound poragens, and/or separately added poragens may be removed.

According to a seventh embodiment, this invention is an article made by the above method, desirably a porous article formed by removal of bound porogens and/or separately added poragens. Desirably, said article contains a homogeneous distribution of pores.

According to an eighth embodiment of the invention, the foregoing article is a film and the construct is a semiconductor device, such as an integrated circuit, incorporating the film as an insulator between circuit lines or layers of circuit lines therein.

The monomers are highly soluble in typical solvents used in fabrication of semiconductor devices, and may be employed in formulations that are coated onto substrates and vitrified to form films and other articles. The compositions including a bound poragen are desirable in order to obtain films having uniformly distributed small pores having a reduced potential for pore collapse or coalescence during the chip manufacturing process, uniform electrical properties, and low dielectric constants.

### DETAILED DESCRIPTION OF THE INVENTION

For purposes of United States patent practice, the contents of any patent, patent application or publication referenced herein is hereby incorporated by reference in its entirety herein, especially with respect to its disclosure of monomer, oligomer or polymer structures, synthetic techniques and general knowledge in the art. If appearing herein, the term “comprising” and derivatives thereof is not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability. The term “consisting of”, if used, excludes any component, step or procedure not specifically delineated or listed. The term “or”, unless apparent from the context or stated otherwise, refers to the listed members individually as well as in any combination.

As used herein the term “aromatic” refers to a polyatomic, cyclic, ring system containing (4δ+2) π-electrons, wherein δ is an integer greater than or equal to 1. The term “fused” as used herein with respect to a ring system containing two or more polyatomic, cyclic rings means that with respect to at least two rings thereof, at least one pair of adjacent atoms is included in both rings.

“A-functionality” refers to a single dienophile group.

“B-functionality” refers to the ring structure comprising two conjugated carbon-to-carbon double bonds and a leaving group L.

“b-staged” refers to the oligomeric mixture or low molecular weight polymeric mixture resulting from partial polymerization of a monomer or monomer mixture. Unreacted monomer may be included in the mixture.

“C′-functionality” refers to addition polymerizable-, telechelic-, or graftable-functional groups, excluding groups capable of cycloaddition reactions with acetylenic- or conjugated diene functionality. Accordingly, C′ functional groups are not A or B groups.

“Cross-linkable” refers to a matrix precursor that is capable of being irreversibly cured, to a material that cannot be reshaped or reformed. Cross-linking may be assisted by thermal, UV, microwave, x-ray, or e-beam irradiation.

“Dienophile” refers to a group that is able to react with the conjugated, double bonded carbon groups according to the present invention, preferably in a cycloaddition reaction involving elimination of the L group and aromatic ring formation.

“Inert substituent” means a substituent group which does not interfere with any subsequent desirable polymerization reaction of the monomer or b-staged oligomer and does not include further polymerizable moieties as disclosed herein.

“Matrix precursor” means a monomer, prepolymer, polymer, or mixture thereof which upon curing or further curing, forms a cross-linked polymeric material.

“Monomer” refers to a polymerizable compound or mixture thereof “Matrix” refers to a continuous phase surrounding dispersed regions of a distinct composition or void.

“Poragen” refers to polymeric or oligomeric components that may be combined with the monomers, oligomers or polymers of the invention, and which may be removed from the initially formed oligomer or, more preferably, from the vitrified (that is the fully cured or cross-linked) polymer matrix, resulting in the formation of voids or pores in the polymer. Poragens may be removed from the matrix polymer by any suitable technique, including dissolving with solvents or, more preferably, by thermal decomposition. A “bound poragen” refers to a poragen that is chemically bound or grafted to the monomer, oligomer, or vitrified polymer matrix through reaction with a C′-functional group.

The Monomers and Their Syntheses

The monomers of the present invention preferably comprise one or more dienophilic functional groups, preferably an arylacetylenic group; one or more hydrocarbon- or heteroatom substituted hydrocarbon-rings having two conjugated carbon to carbon double bonds and the leaving group, L; one or more addition polymerizable (other than by means of a cycloaddition), telechelic, or graftable functional groups; and, optionally, inert substituents or components.

Preferred B-functional groups comprise cyclic, five-membered, conjugated diene rings where L is —O—, —S—, —(CO)—, or —(SO₂)—, or a six membered, conjugated diene ring where L is —N═N—, or —O(CO)—. Optionally, two of the carbon atoms of the ring structure and their substituent groups taken together may also form an aromatic ring, that is, the 5 or 6 membered ring structures may be part of a fused, multiple aromatic ring system.

Most preferably, L is —(CO)— such that the ring is a cyclopentadienone group or benzcyclopentadienone group. Examples of such most preferred cyclopentadienone rings are those containing aryl groups at the 2, 3, 4, or 5 positions thereof, more preferably at the 2, 3, 4 and 5 positions thereof.

Preferred dienophile groups (A-functionality) are unsaturated hydrocarbon groups, most preferably ethynyl or phenylethynyl groups.

Preferred C′-functionality are benzocyclobutene, pyrone, cyclopentadiene, cyclopropane, or ethylenically unsaturated groups. Examples of ethylenically unsaturated groups include, vinylaromatic, acrylate, methacrylate and vinyl ether groups.

The monomers of the present invention may be depicted generically by the formula: AxByC′z, wherein A, B and C′ stand for A-functionality, B-functionality and C′-functionality respectively, and x, y and z are integers greater than or equal to one.

Examples of suitable monomers according to the invention are compounds corresponding to the formula,

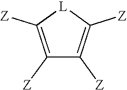

wherein L is —O—, —S—, —N═N—, —(CO)—, —(SO₂)—, or —O(CO)—;

Z is independently in each occurrence hydrogen, halogen, an unsubstituted or inertly substituted hydrocarbyl group, especially an aryl group, more especially a phenyl group, Z″, or two adjacent Z groups together with the carbons to which they are attached form a fused aromatic ring,

Z″ is a divalent derivative of an unsubstituted or inertly substituted hydrocarbyl group joining two or more of the foregoing structures, or joining an A-functionality, a C-functionality and/or a combination of the foregoing,

and in at least one occurrence, Z is —Z″C≡CR¹; or

in at least one occurrence, Z is —Z″—C≡CR² and in at least one other occurrence Z is a C′-functionality; wherein,

R¹ is independently each occurrence selected from the group consisting of groups containing C′-functionality; and

R² is independently each occurrence selected from the group consisting of hydrogen, C₁₋₄ alkyl, C₆₋₆₀ aryl, and C₇₋₆₀ inertly substituted aryl groups.

Preferred monomers according to the present invention are 3-substituted cyclopentadienone compounds or 3,4-disubstituted cyclopentadienone compounds, represented by the formula: 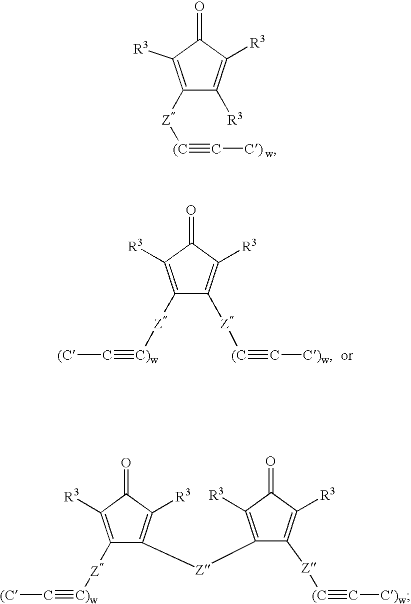
wherein R³ is C₆₋₂₀ aryl or inertly substituted aryl, more preferably, phenyl, biphenyl, p-phenoxyphenyl or naphthyl,

w independently each occurrence is an integer from 1 to 3, more preferably 1,

Z″ is a divalent aromatic group, more preferably phenylene, biphenylene, phenyleneoxyphenylene, and

C′ is as previously defined.

Highly preferred examples of the foregoing monomers are those wherein C′ functionality is represented by the following structures:

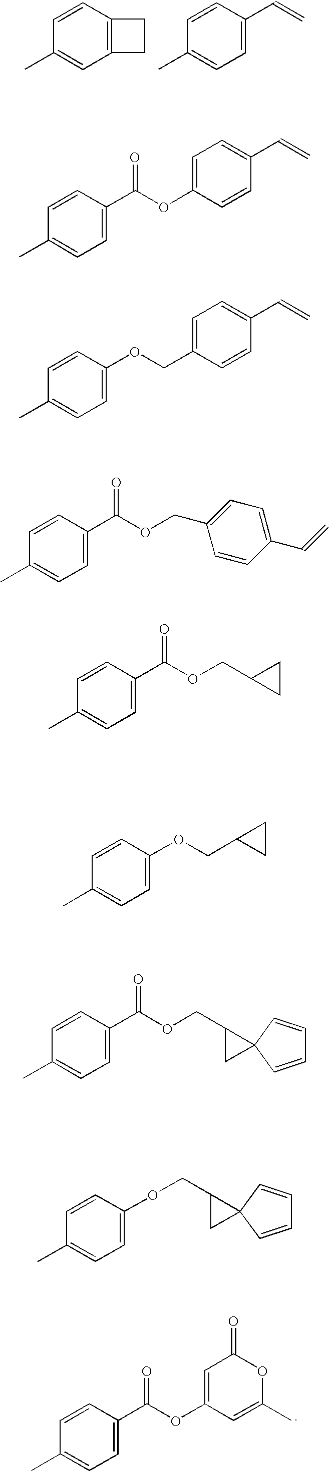

Most highly preferred monomers according to the present invention are those wherein C′ is a benzocyclobutane functionality, especially those corresponding to the formula: 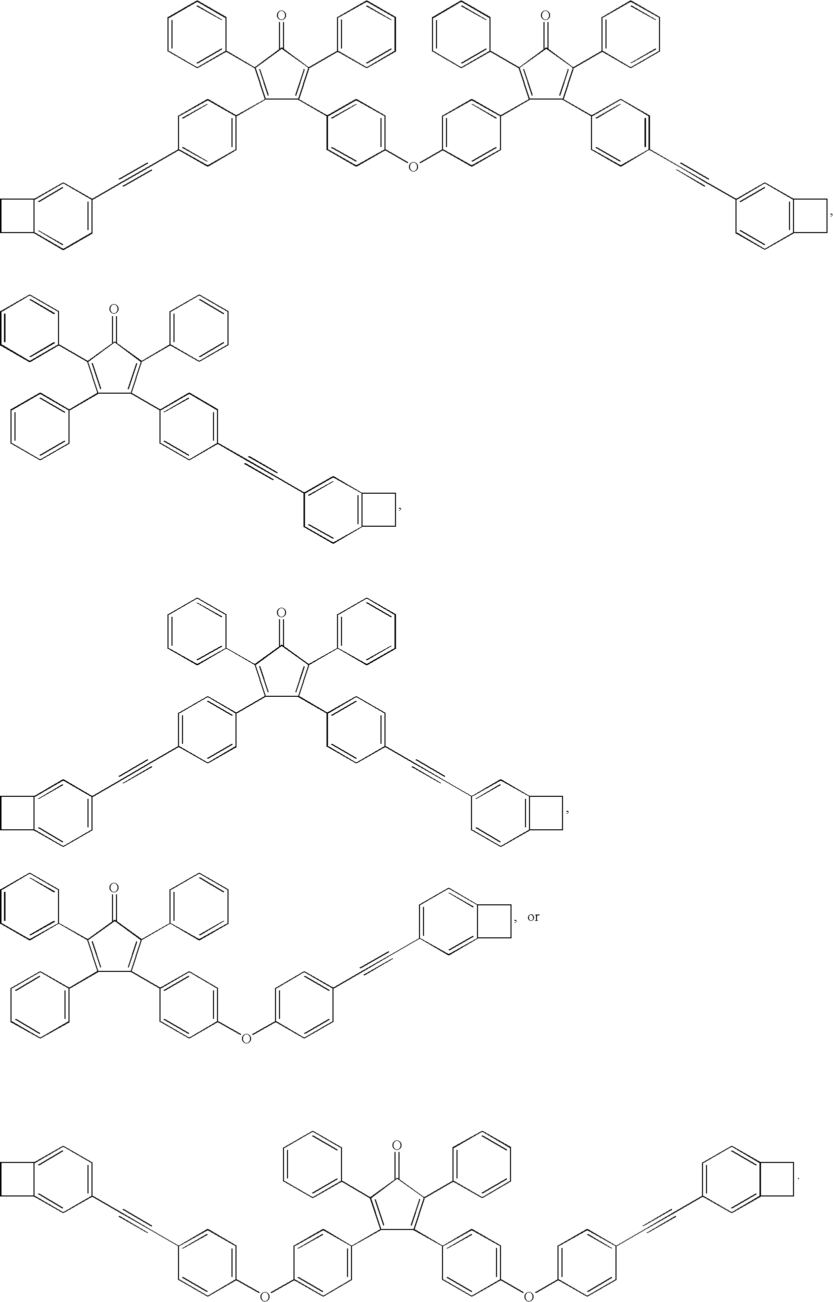
Synthesis of AxByC′z Monomers

The monomers according to the present invention may be made by the condensation of diaryl-substituted acetone compounds with aromatic polyketones using conventional methods. Exemplary methods are disclosed in Macromolecules. 28, 124-130 (1995); J. Org. Chem, 30, 3354 (1965); J. Org. Chem., 28, 2725 (1963); Macromolecules, 34, 187 (2001); Macromolecules, 12, 369 (1979); J. Am. Chem. Soc. 119, 7291 (1997); and U.S. Pat. No. 4,400,540.

More preferably, the monomers may be made by the condensation of the following synthons, or molecular components, wherein R and R₁ are either H, phenylethynyl, or a C′ substituted phenylethynyl group.

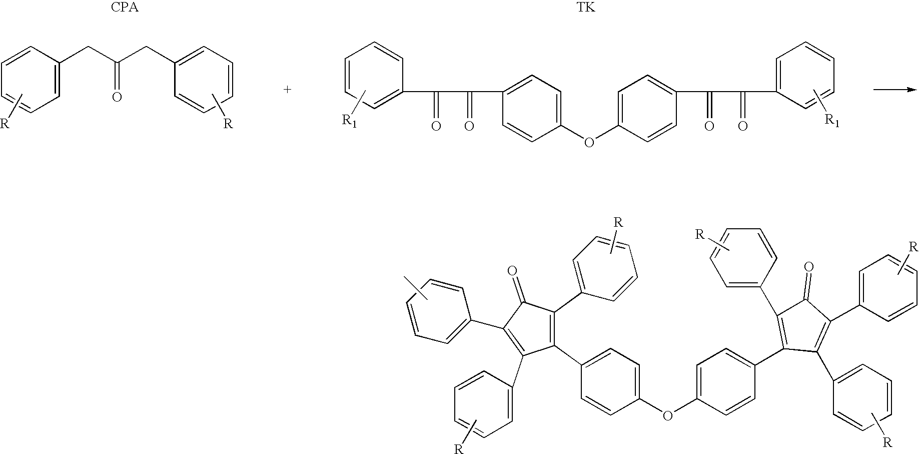

Example of diphenylacetone or DPA synthones are represented by following formulas, where C′ groups are as previously defined:

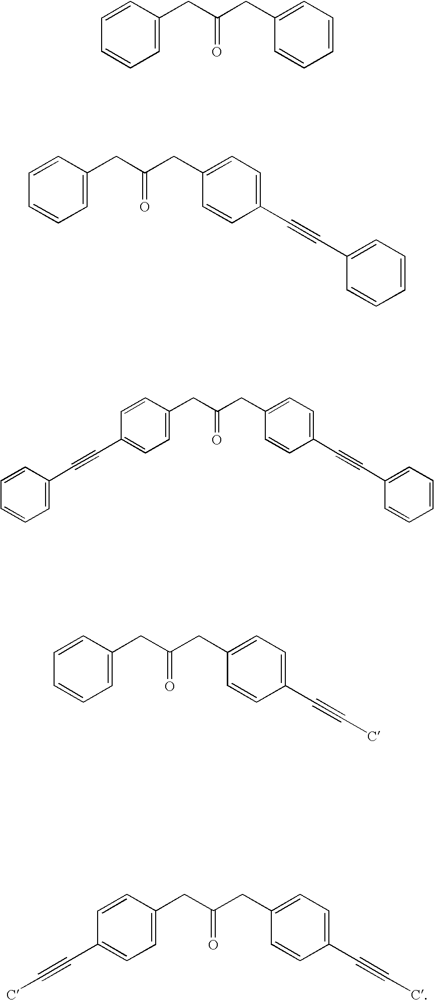

Example of tetraketone or TK synthons are represented by following formulas, where C′ groups are as previously defined:

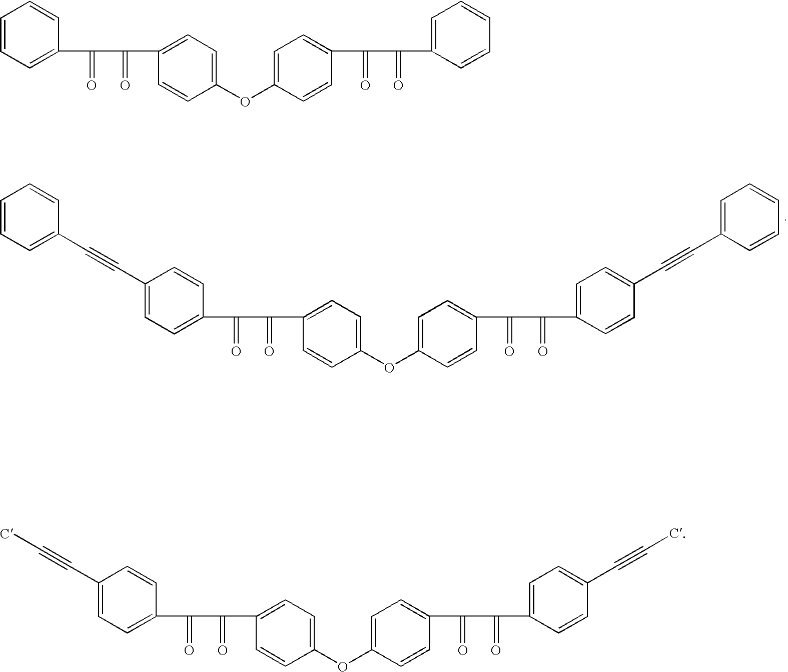

Various TK and DPA synthons can be combined to produce any desired AxByC′z monomer, preferably A₂B₂C′₂ monomers. The key steps are shown in the following scheme:

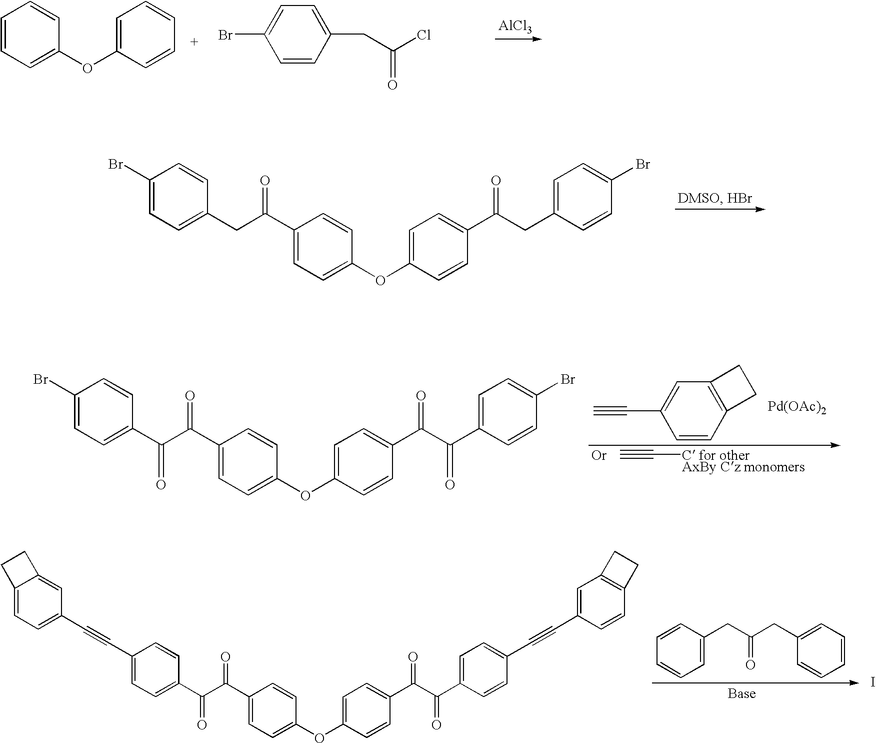

Briefly, said methods comprise: (a) Friedel-Crafts diacylation of diphenylether with 4-bromophenylacetylchloride, (b) modified Komblum oxidation of the diacylation product using dimethylsulfoxide and hydrobromic acid, (c) bis(phenylethynylation) of the bis-4-bromophenyl tetraketone with benzocyclobutaneacetylene (BCB phenylacetylene) using palladium catalysts, a tertiary amine, and a solvent which is essentially inert to both reactants and products, (at this point in the synthesis, BCB phenylacetylene can be substituted by other functional group substituted phenylacetylene compounds to give different C′ groups in the monomers), and finally, (d) bis(cyclopentadienone) formation via double Aldol reaction of the bis(BCB ethynyl tetraketone with 1,3-diphenylacetone using a quaternary ammonium hydroxide catalyst and one or more solvents that are essentially inert to both reactants and products.

B-staging of AxByC′z Monomer

Preparation of oligomers and partially cross-linked polymers (b-staging) can be represented in one embodiment employing an A₂B₂C′₂ monomer by the following illustration, where FG stands for an unreacted functional group; a cross-linking polymer chain; a chain ending group, for example a pheneyethynyl or cyclopentadienone group; or a combination thereof. Similar cross-linked polymers may be prepared as well.

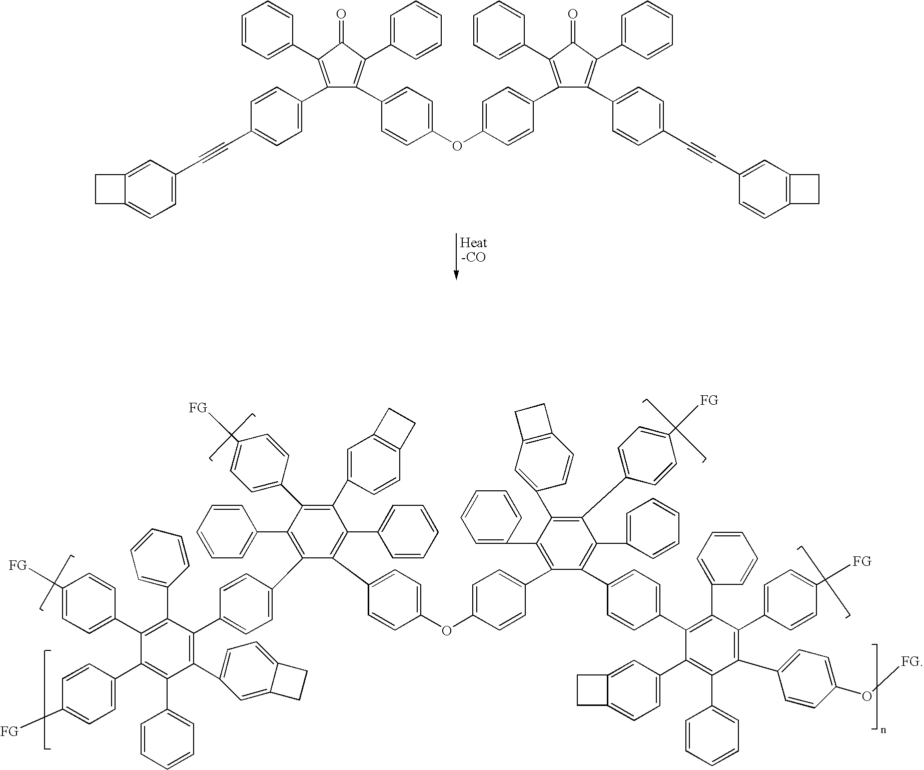

While not desiring to be bond by their belief, it is believed that polyphenylene oligomers and polymers are formed through a Diels-Alder reaction of the cyclopentadienone with the acetylene group when the mixture of monomer and an optional solvent is heated. The product may still contain quantities of cyclopentadienone and acetylene end groups and/or pendent C′ groups. Upon further heating of the mixture or an article coated therewith, additional crosslinking can occur through the Diels-Alder reaction of the remaining cyclopentadienone or B groups with the remaining acetylene or A groups and an increase in molecular weight or through the self-reaction of C′ groups. Ideally, cyclopentadienone and acetylene groups are consumed at the same rate under Diels-Alder reaction conditions, preferably at temperatures from 280 to 350° C., more preferably from 285 to 320° C. The temperature is desirably selected such that minimal or no reaction between two A groups or two B groups occurs. However, in one embodiment, improved polymer properties are obtainable by the reaction of at least some C′ functional groups with one another, prior to or concomitant with reaction between A and B groups. In the case of benzocyclobutane (BCB) C′ groups, this self reaction results primarily in formation of 8-membered rings fused between phenylene groups of the polyphenylene polymer.

The cross-linking reaction is preferably halted prior to the reaction of significant quantities of A, B, and/or C′ functionality to avoid gel formation. The oligomer may then be applied to a suitable surface prior to further advancement or curing of the composition. While in an oligomerized or b-stage, the composition is readily applied to substrates by standard application techniques, and forms a level surface coating which covers (planarizes) components, objects or patterns on the surface of the substrate. Preferably, at least ten percent of the monomer remains unreacted when b-staged. Most preferably, at least twenty percent of the monomer remains unreacted. One may determine the percentage of unreacted monomer by visible spectra analysis or SEC analysis.

Suitable solvents for preparing coating compositions of b-staged compositions include mesitylene, methyl benzoate, ethyl benzoate, dibenzylether, diglyme, triglyme, diethylene glycol ether, diethylene glycol methyl ether, dipropylene glyco methyl ether, dipropylene glycol dimethyl ether, propylene glycol methyl ether, dipropylene glycol monomethyl ether acetate, propylene carbonate, diphenyl ether, butyrolactone and ethoxyethylpropionate. The preferred solvents are mesitylene, gamma-butyrolactone, diphenyl ether, ethoxyethylpropionate and mixtures thereof.

Alternatively, the monomers can be polymerized in one or more solvents at elevated temperature and the resulting solution of oligomers can be cooled and formulated with one or more additional solvents to aid in processing. In another approach, the monomer can be polymerized in one or more solvents at elevated temperature to form oligomers which can be isolated by precipitation into a non solvent. These isolated oligomers can then be redissolved in a suitable solvent for processing.

The monomers of the present invention or b-staged oligomers thereof are suitably employed in a curable composition alone or as a mixture with other monomers containing two or more functional groups (or b-staged oligomers thereof) able to polymerize by means of a Diels-Alder or similar cycloaddition reaction. Examples of such other monomers include compounds having two or more cyclopentadienone functional groups and/or acetylene functional groups or mixtures thereof, such as those previously disclosed in U.S. Pat. Nos. 5,965,679 and 6,359,091. In the b-stage curing reaction, a dienophilic group reacts with the cyclic diene functionality, causing elimination of L and aromatic ring formation. Subsequent curing or vitrification may involve a similar cycloaddition or an addition reaction involving only the dienophilic functional groups.

Additional polymerizable monomers containing A, B and/or C′ functionality may be included in a curable composition according to the present invention. Examples include compounds of the formula: 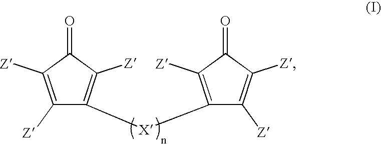
wherein

Z′ is independently in each occurrence hydrogen, an unsubstituted or inertly substituted aromatic group, an unsubstituted or inertly substituted alkyl group, or —W—(C≡Q)_{q};

X′ is an unsubstituted or inertly substituted aromatic group, —W—C≡C—W—, or

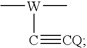

W is an unsubstituted or inertly substituted aromatic group, and

Q is hydrogen, an unsubstituted or inertly substituted C₆₋₂₀ aryl group, or an unsubstituted or inertly substituted C₁₋₂₀ alkyl group, provided that at least two of the X′ and/or Z′ groups comprise an acetylenic group,

q is an integer from 1 to 3; and

n is an integer of from 1 to 10.

Examples of the foregoing polyfunctional monomers that may be used in conjunction with the monomers of the present invention include compounds of formulas II-XXV:

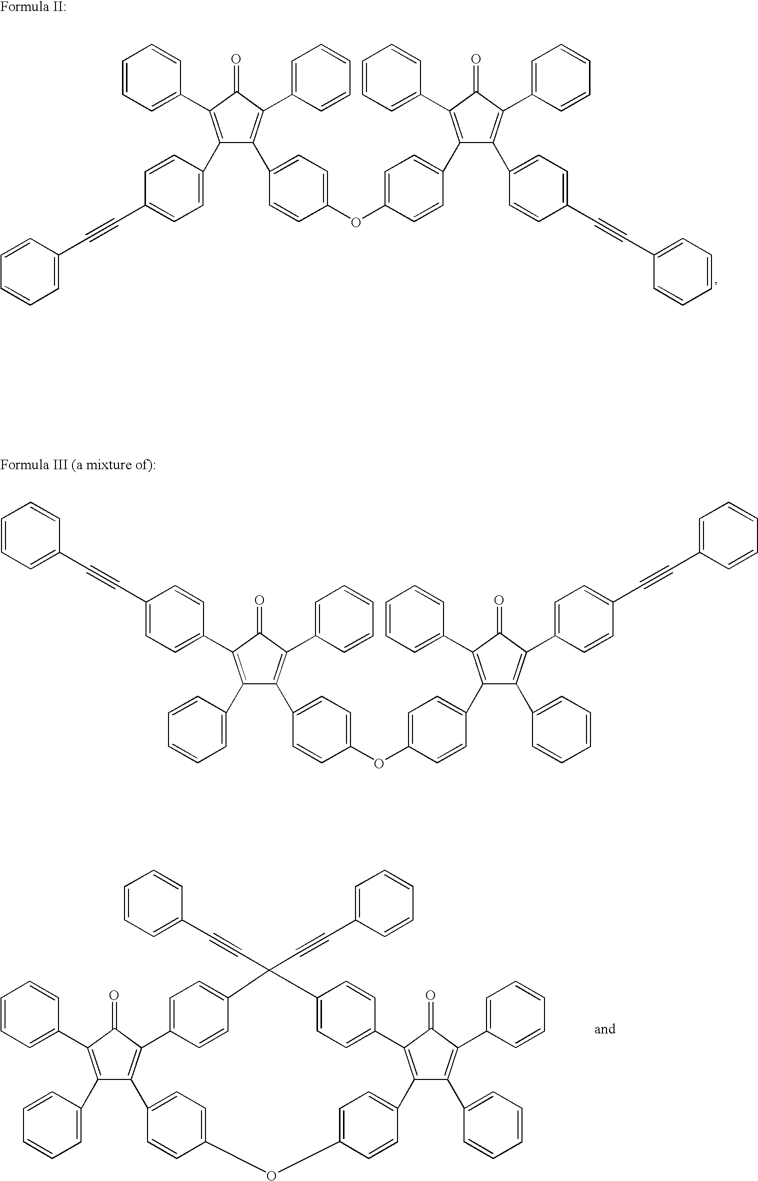

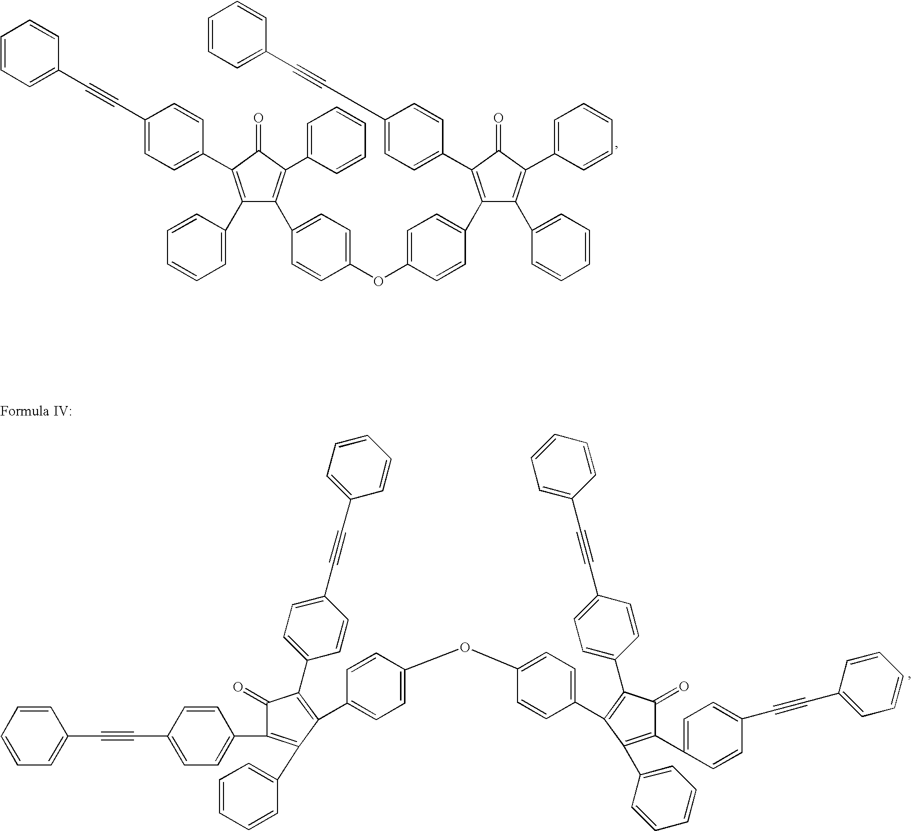

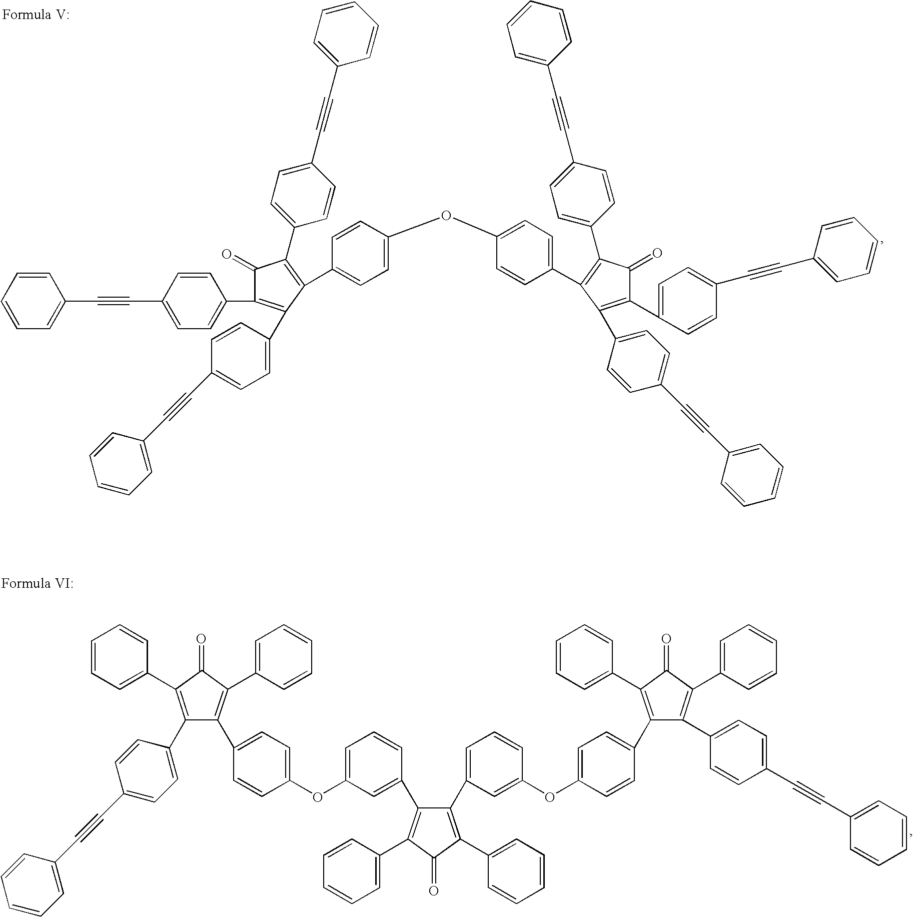

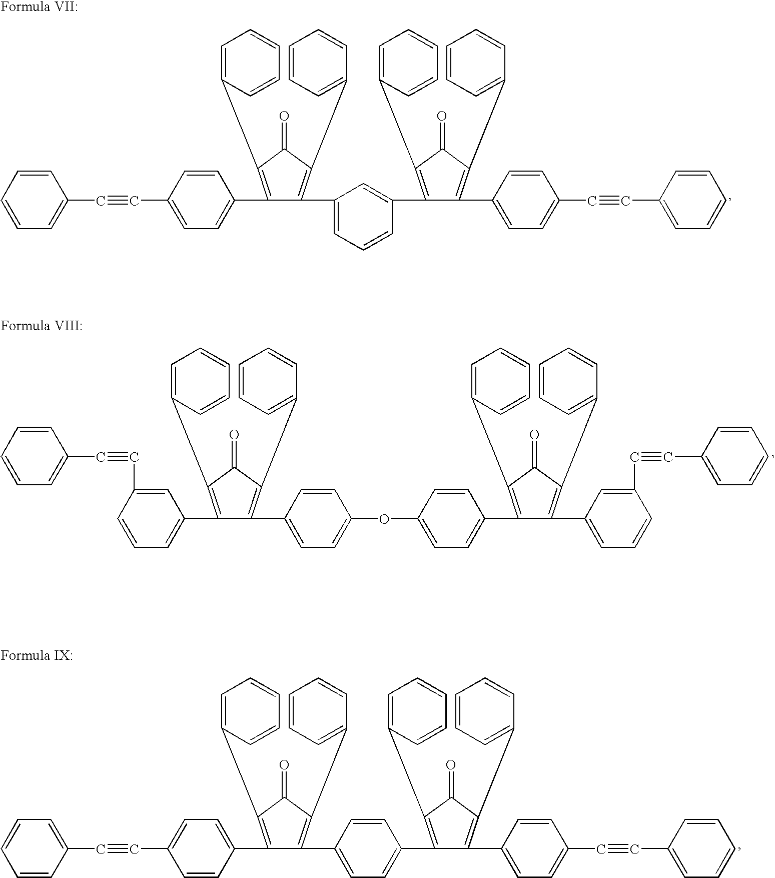

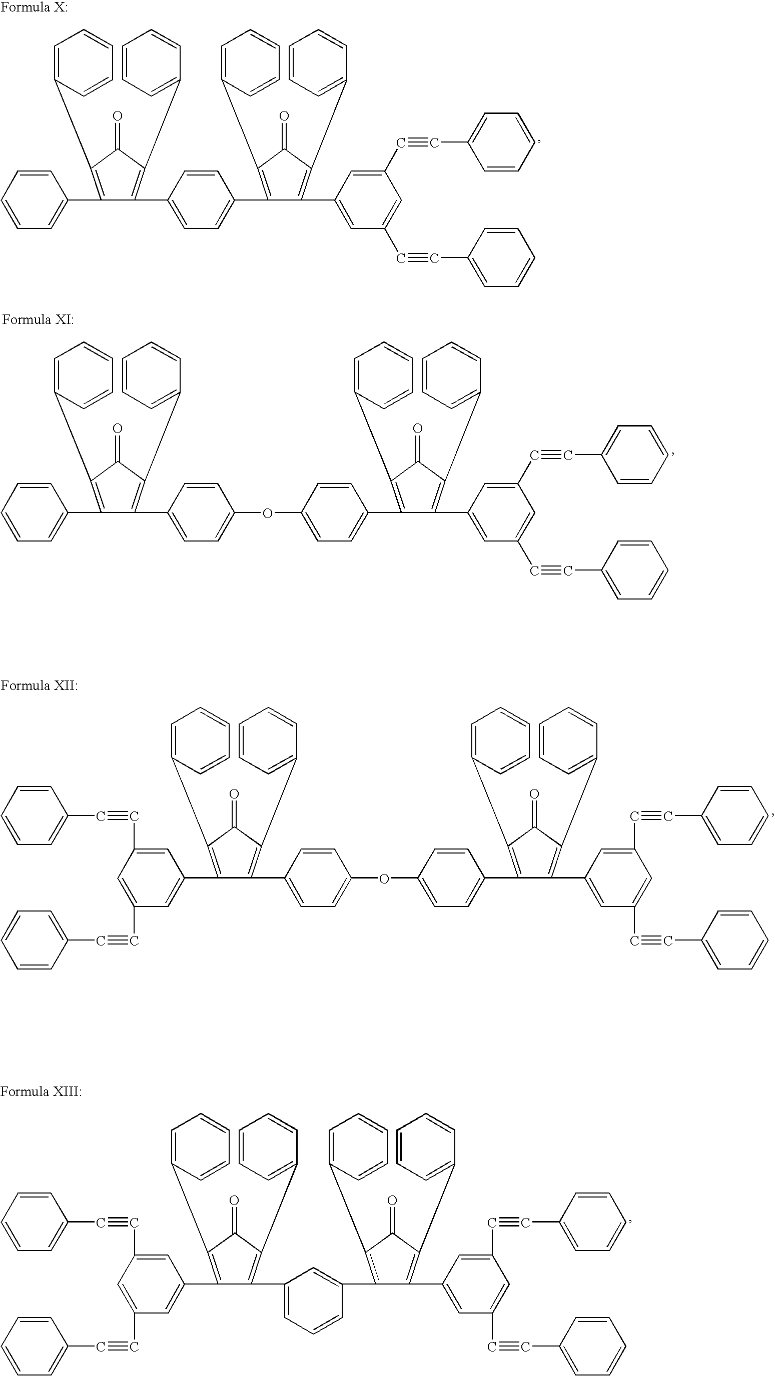

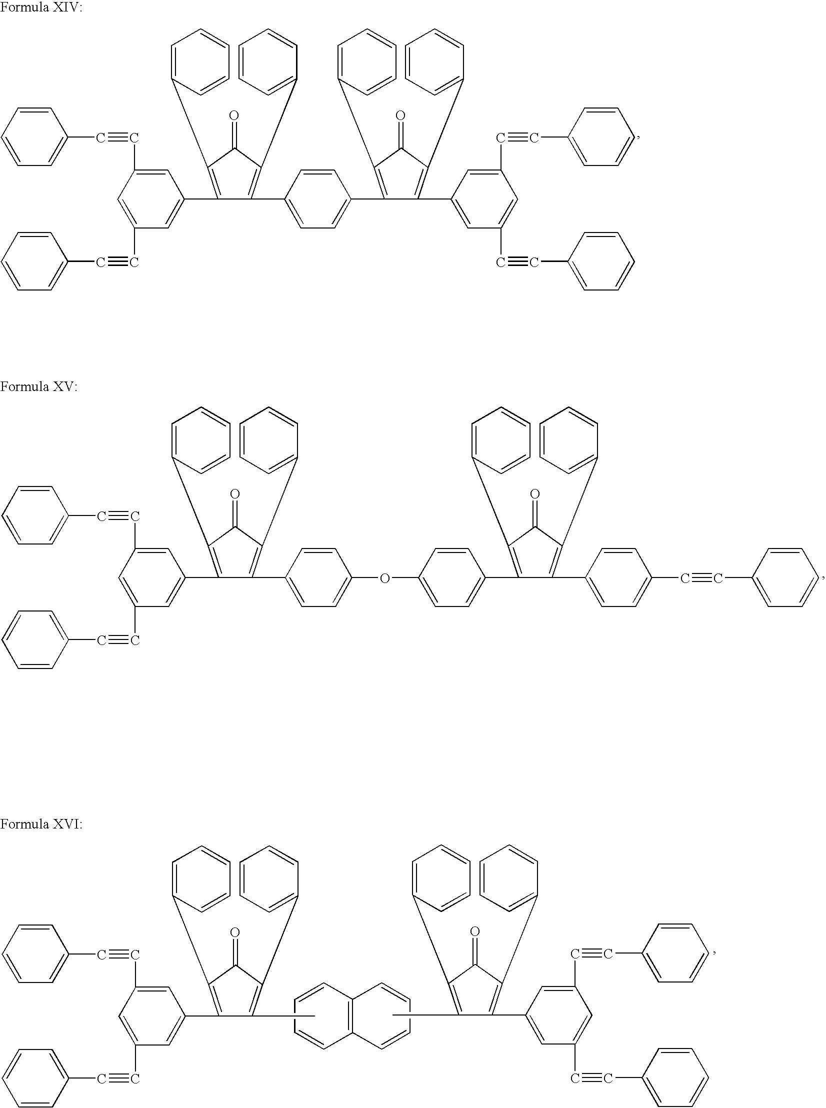

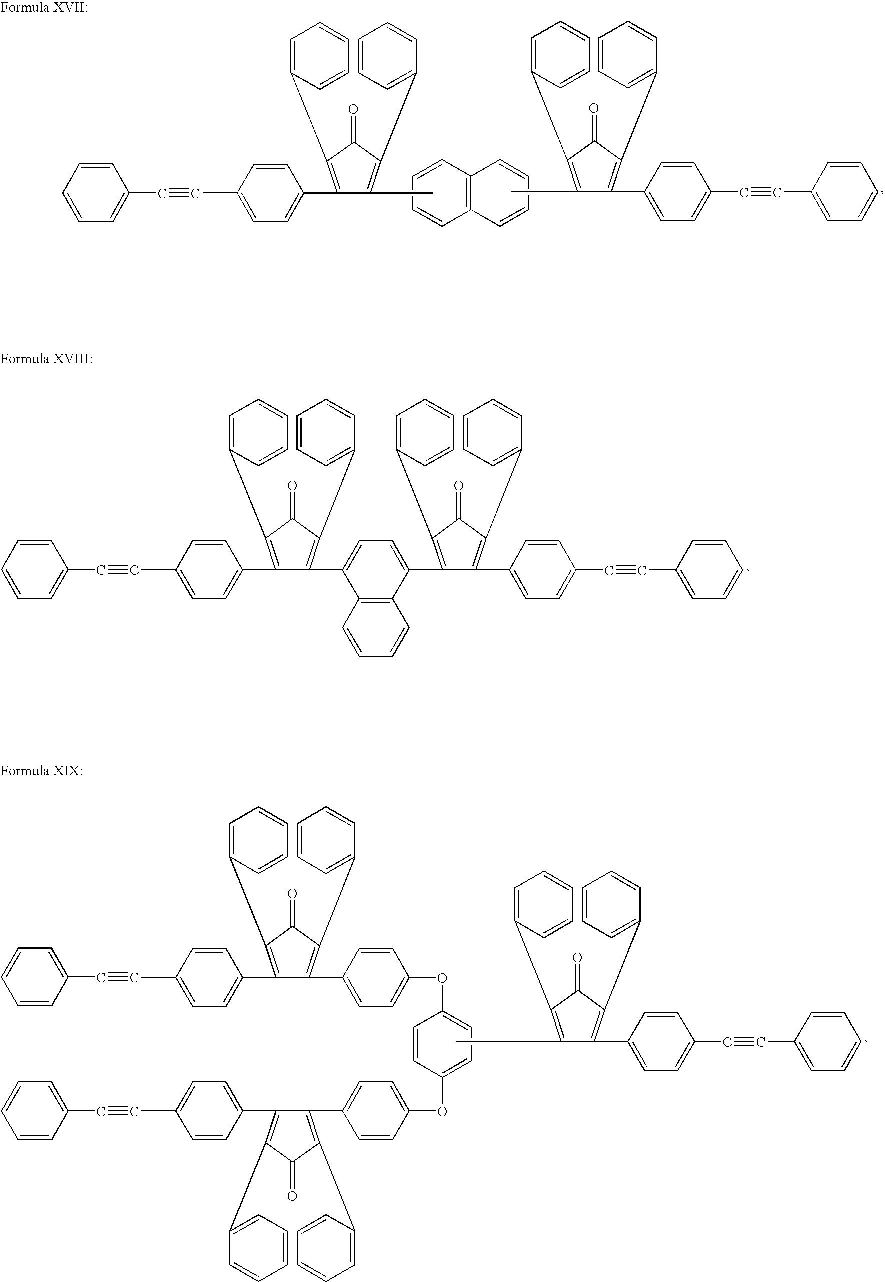

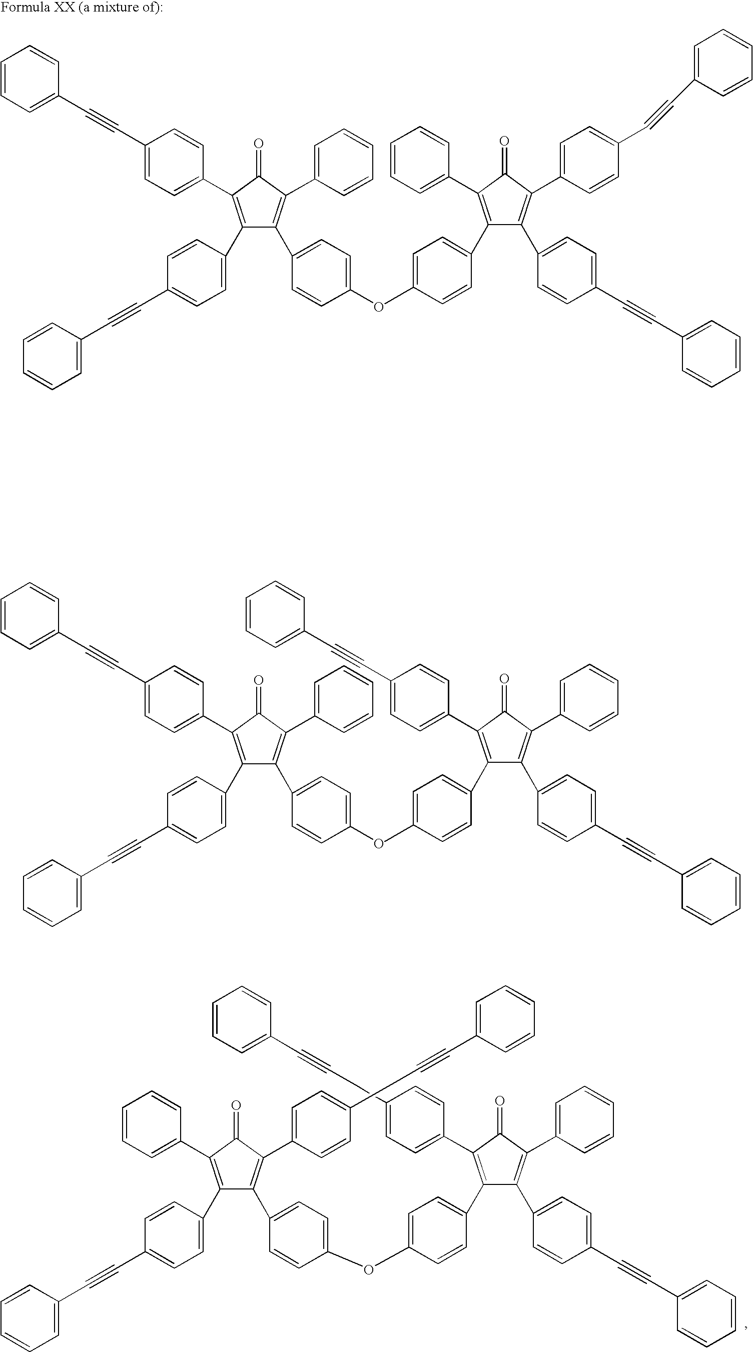

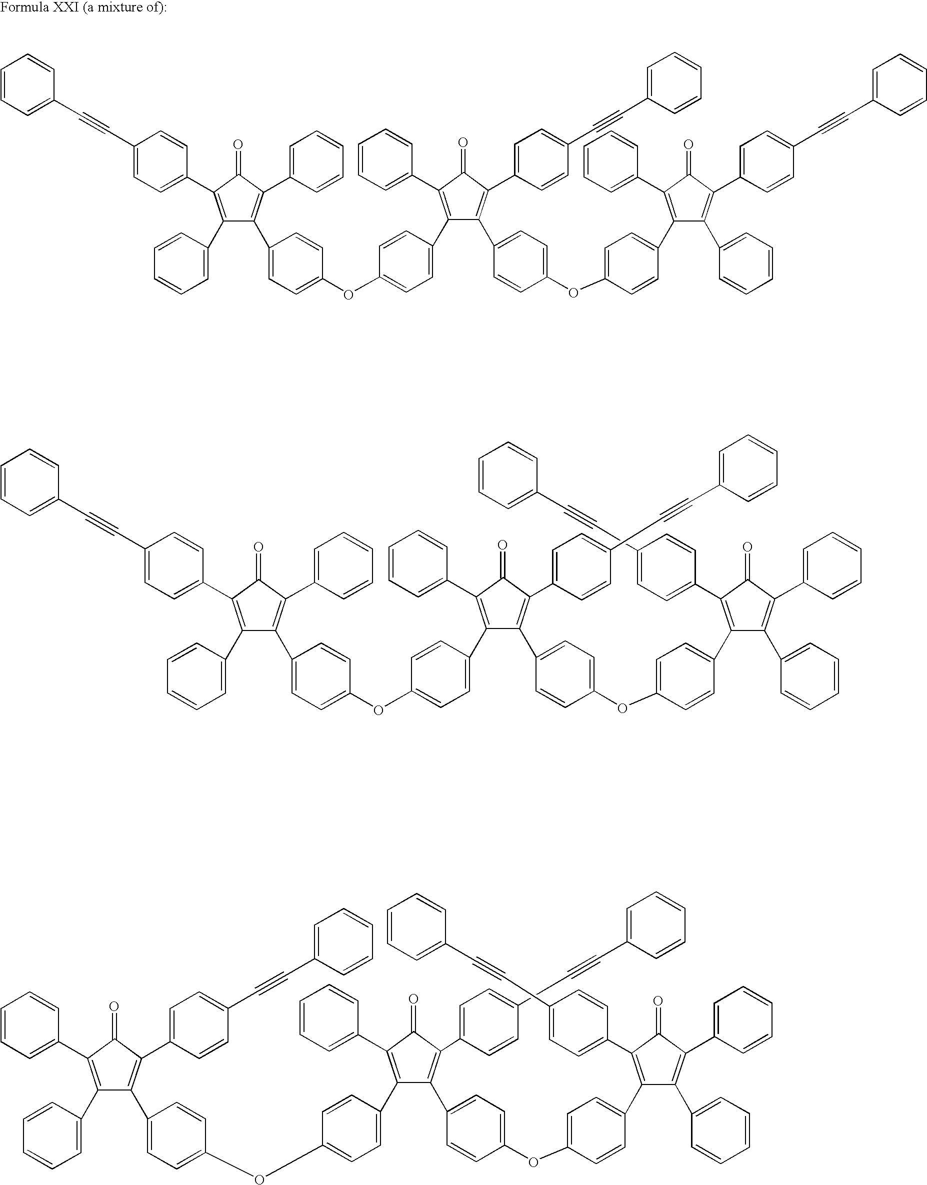

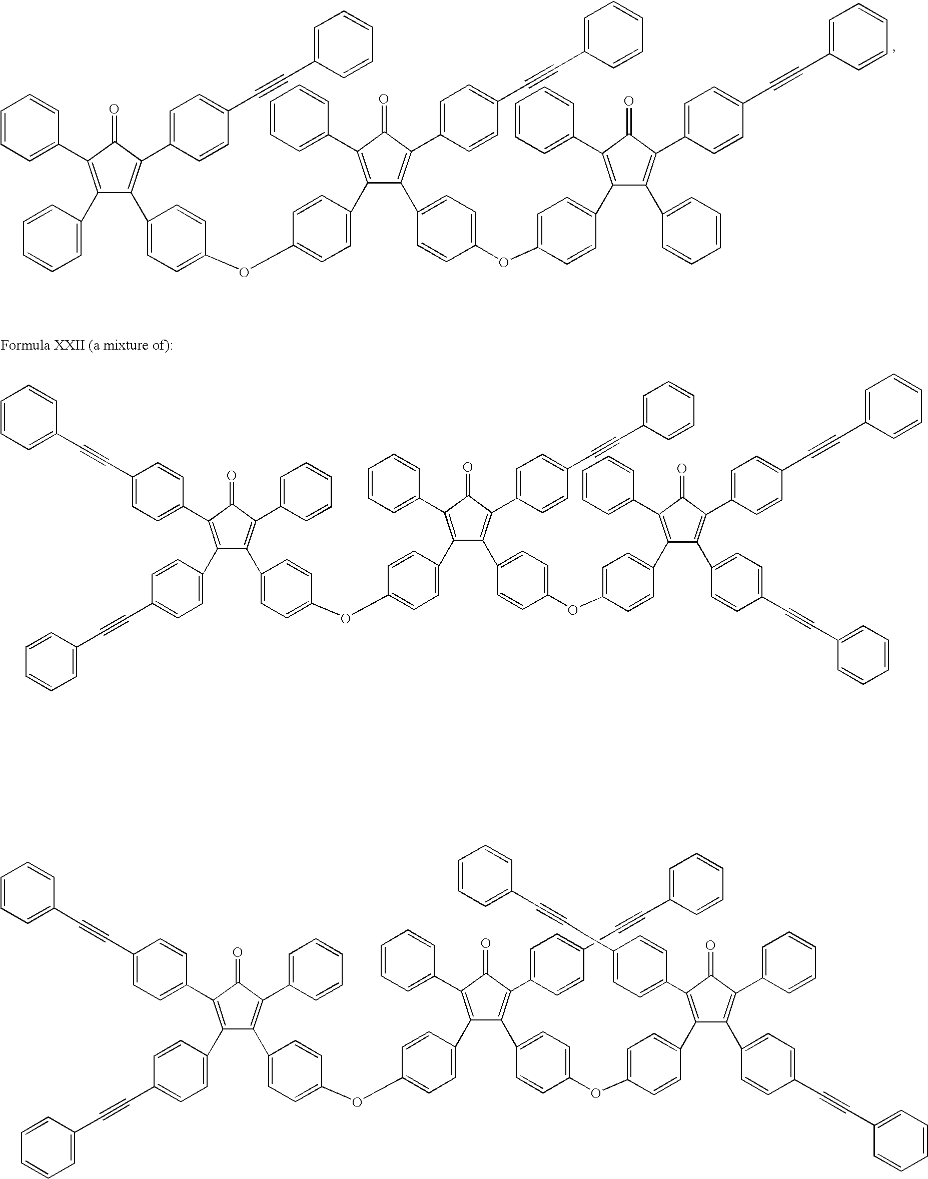

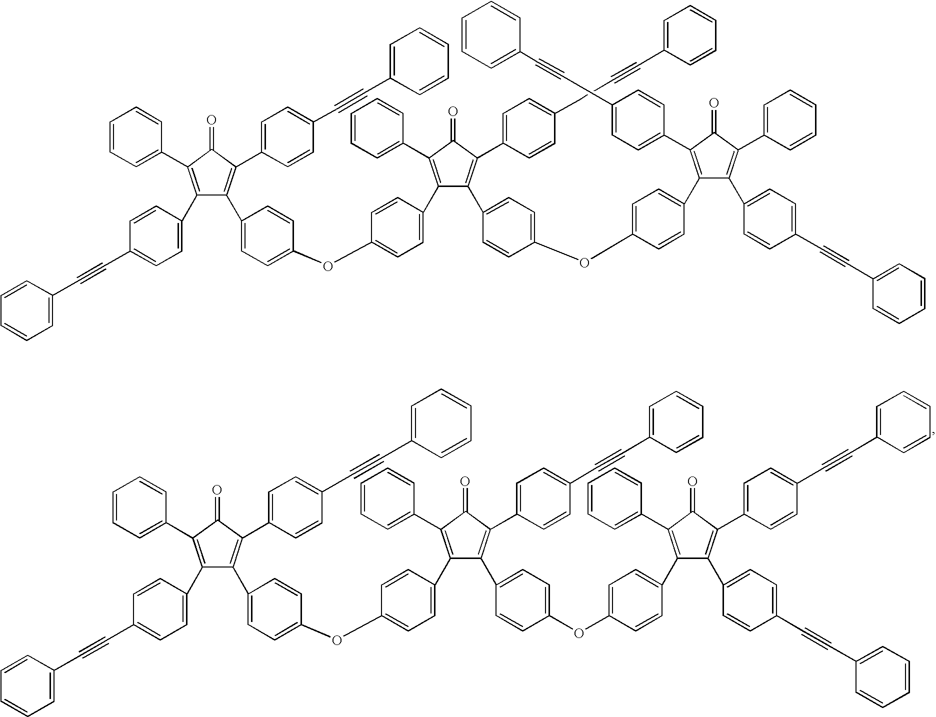

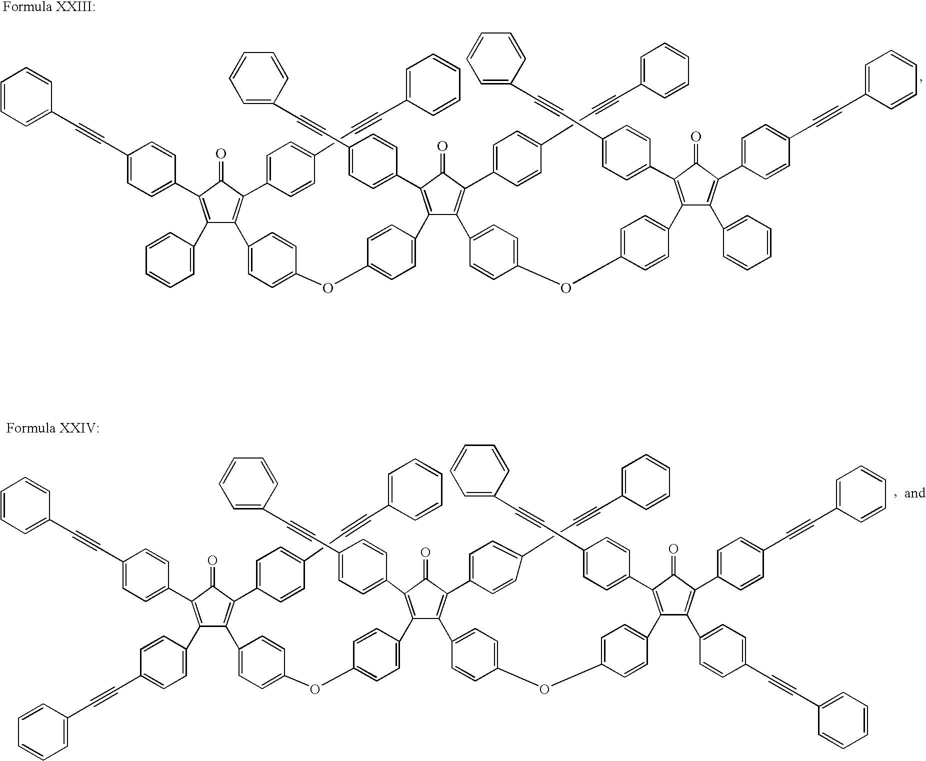

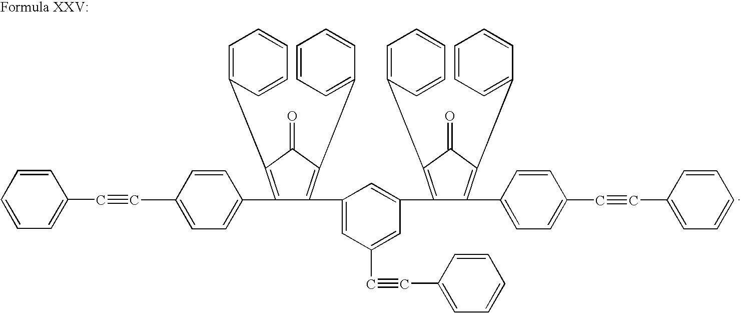

The foregoing monomers I-XXV where the ring structure is a cyclopentadienone may be made, for example, by condensation of substituted or unsubstituted benzils with substituted or unsubstituted benzyl ketones (or analogous reactions) using conventional methods such as those previously disclosed with respect to AxByC′z monomers. Monomers having other structures may be prepared as follows: Pyrones can be prepared using conventional methods such as those shown in the following references and references cited therein: Braham et. al., Macromolecules (1978), 11, 343; Liu et. al., J. Org. Chem. (1996), 61, 6693-99; van Kerckhoven et. al., Macromolecules (1972), 5, 541; Schilling et. al. Macromolecules (1969), 2, 85; and Puetter et. al., J. Prakt. Chem. (1951), 149, 183. Furans can be prepared using conventional methods such as those shown in the following references and references cited therein: Feldman et. al., Tetrahedron Lett. (1992), 47, 7101, McDonald et. al., J. Chem. Soc. Perkin Trans. (1979), 1 1893. Pyrazines can be prepared using methods such as those shown in Turchi et. al., Tetrahedron (1998), 1809, and references cited therein.

In a preferred embodiment of the invention employing mixtures of the present monomers and other monomers as previously disclosed, it is desirable to maintain a ratio of the corresponding A-functionality and B-functionality in the mixture such that the ratio of B-functional groups to A-functional groups in the reaction mixture is in the range of 1:10 to 10:1, and most preferably from 2:1 to 1:4. It is further desirable to maintain a ratio of A-functional groups to C′-functional groups in the reaction mixture in the range of 1:1 to 10:1, and most preferably from 2:1 to 10:1. Preferably, the composition additionally comprises a solvent and optionally may also comprise a poragen.

Suitable poragens for use herein include any compound that can form small domains in a matrix formed from the monomers and which can be subsequently removed, for example by thermal decomposition. Preferred poragens are polymers including homopolymers and interpolymers of two or more monomers including graft copolymers, emulsion polymers, and block copolymers. Suitable thermoplastic materials include polystyrenes, polyacrylates, polymethacrylates, polybutadienes, polyisoprenes, polyphenylene oxides, polypropylene oxides, polyethylene oxides, poly(dimethylsiloxanes), polytetrahydrofurans, polyethylenes, polycyclohexylethylenes, polyethyloxazolines, polyvinylpyridines, polycaprolactones, polylactic acids, copolymers of the monomers used to make these materials, and mixtures of these materials. The thermoplastic materials may be linear, branched, hyperbranched, dendritic, or star-like in nature. The poragen may also be designed to react with the cross-linkable matrix precursor or oligomer during or subsequent to b-staging to form blocks or pendant substitution of the polymer chain. For example, thermoplastic polymers containing reactive groups such as vinyl, acrylate, methacrylate, allyl, vinyl ether, maleimido, styryl, acetylene, nitrile, furan, cyclopentadienone, perfluoroethylene, BCB, pyrone, propiolate, or ortho-diacetylene groups can form chemical bonds with the cross-linkable matrix precursor or oligomer, especially with C′ functionality thereof.

The poragen is desirably a material that, upon removal, results in formation of voids or pores in the matrix having an average pore diameter from 1 to 200 nm, more preferably from 2 to 100 nm, most preferably from 5 to 50 nm. Suitable block copolymer poragens include those wherein one of the blocks is compatible with cross-linked polymer matrix resin and the other block is incompatible therewith. Useful polymer blocks can include polystyrenes such as polystyrene and poly-α-methylstyrene, polyacrylonitriles, polyethylene oxides, polypropylene oxides, polyethylenes, polylactic acids, polysiloxanes, polycaprolactones, polyurethanes, polymethacrylates, polyacrylates, polybutadienes, polyisoprenes, polyvinyl chlorides, and polyacetals, and amine-capped alkylene oxides (commercially available as Jeffamine™ polyether amines from Huntsman Corp.).

Preferably, the martix precursor or oligomer is chemically bound or grafted to the porogen. This may be accomplished by adding functionalized porogens to the monomer prior to b-staging at a time when functional groups on the porogen or the poragen forming monomer itself are available to react with C′ functionality on the monomers. Alternatively, some b-staging may occur prior to addition of the porogen and the porogen may be grafted to the oligomer by subjecting the mixture to conditions sufficient to cause a grafting reaction to occur or to otherwise cause residual functional groups on the porogen to react with C′ groups in the b-staged reaction product. The mixture is then coated onto a substrate (preferably solvent coated as for example by spin coating or other known methods). The matrix is cured and the porogen is removed, preferably by heating to a temperature above the thermal decomposition temperature of the poragen. Porous films prepared in this manner are useful in making integrated circuit articles where the film separates and electrically insulates conductive metal lines from each other.

Highly preferred poragens are crosslinked polymers made by solution or emulsion polymerization. Such polymerization techniques are known in the art, for example, EP-A-1,245,586, and elsewhere. Very small crosslinked hydrocarbon based polymer particles have been prepared in an emulsion polymerization by use of one or more anionic-, cationic-, or non-ionic surfactants. Examples of such preparations may be found in J. Dispersion Sci. and Tech., vol. 22, No. 2-3, 231-244 (2001); “The Applications of Synthetic Resin Emulsions”, H. Warson, Ernest Benn Ltd., 1972, p. 88; Colloid Polym. Sci., 269, 1171-1183 (1991), Polymer. Bull. 43, 417-424 (1999), PCT 03/04668, filed Feb. 12, 2003 and U.S. Ser. No. 10/366,494, filed Feb. 12, 2003, among other sources.

In addition, small, uniformly dispersed poragens may be formed in situ, by polymerization of one or more addition polymerizable monomers, telegens or graft forming comonomers with the C′ functionality of the monomer or a b-stage oligomer of the invention. In this embodiment, the size of the resulting bound poragens can be controlled by limiting the amount of comonomer that is allowed to react with the AxByC′z monomer or oligomer thereof. This results in uniform, extremely small poragens in the resin, and uniform, extremely small pores (nanopores) in the vitrified resin matrix. In both of the foregoing procedures, an oligomeric or polymeric moiety is chemically bound by means of C′ functionality, prior to, simultaneously with, or after cross-linking of the invented compounds.

Porous Matrix from AxByC′z Monomers and Oligomers

In the present invention, the C′ functionality provides a template that directs placement of bound poragens resulting in uniform, homogeneous porosity in the resulting vitrified resins. For example, a mixture of A₂B₂C′₂ monomer and an poragen forming compound such as an addition polymerizable monomer, may be mixed in a suitable solvent and b-staged at moderately elevated temperature to form oligomeric products grafted with in situ prepared polymeric, bound poragens. The resulting precursor may be coated onto the surface of an article such as a microelectronic device and heated to vitrify the oligomer, thereby fixing the desired nanostructure. Subsequently to or simultaneously with the vitrification, the bound poragen may be removed leaving the desired, highly uniform, porous structure.

Desirably, the bound poragen is selected so that a porous, closed cell structure is obtained wherein the pore domains are from 10 to 20 nm in average diameter and not interconnected. The nature of the addition polymerizable monomer, telegen, or graftable monomer utilized to prepare the bound poragen is chosen based on a number of factors, including the size and shape of the pore to be generated, the method of poragen decomposition, the level of any poragen residue permitted in the porous nanostructure, and the reactivity or toxicity of any decomposition products formed. It is also important that the matrix have enough crosslinking density to support the resulting porous structure.

In particular, the temperature at which pore formation occurs should be carefully chosen to be sufficiently high to permit prior solvent removal and at least partial vitrification of the b-staged oligomer, but below the glass temperature, Tg, of the vitrified matrix. If pore formation takes place at a temperature at or above the Tg of the matrix, partial or full collapse of the pore structure may result.

Examples of suitable bound poragens for use herein include moieties having different macromolecular architectures (linear, branched, or dendritic) and different chemical identities, including polyacrylates, polymethacrylates, polybutadiene, polyisoprenes, polypropylene oxide, polyethylene oxide, polyesters, polystyrene, alkyl-substituted polystyrene, and all copolymer combinations, including block copolymers, and functionalized derivatives thereof. Preferably, substances used to prepare bound poragens have one or more functional groups to react with C′ groups in the AxByC′z monomer or oligomer. Suitable functionalized polymeric substances include, vinyl capped polystyrene, vinyl capped crosslinked polystyrene copolymers, vinyl capped polystyrene bottlebrush, and vinyl capped polystyrene star shaped polymers. Most preferably, the bound poragen forming compound is a crosslinked vinyl aromatic microemulsion particle (P) containing addition polymerizable vinyl functional groups.

MEPs are intramolecularly crosslinked molecular species of extremely small particle size possessing a definable surface of approximately spherical shape. Highly desirably, the MEP's have an average particle size from 5 to 100 nm, most preferably from 5 to 20 nm. Preferably, the MEP is functionalized with an addition polymerizable group such as vinyl group, allowing for ready incorporation into the AxByC′z monomer or oligomer. Desirably the grafting level of the functionalized MEP is sufficient to result in self-alignment, thereby resulting in discrete microphase separation of the MEP's. Upon thermal treatment, the MEP phase may decompose while cross-linking of A and B functionality of the monomer proceeds, thereby forming cross-linked oligomers or vitrified solids with homogeneously distributed nanosize voids in a single step.

Alternatively, the bound poragen can be prepared by reaction of C′ functionality, especially ethylenic unsaturation, with an addition polymerizable monomer or telegen to form a grafted polymer. An example is the reaction of a vinyl capped polystyrene or a vinyl capped styrene oligomer with the AXByC′z monomer or oligomer to make a block structure as shown in following scheme where m and n are integers greater than or equal to one:

Using different AxByC′z starting monomers block copolymer or random copolymers with a variety of architectures can be prepared. One reaction scheme is depicted as follows, where m and n are again integers greater than or equal to one:

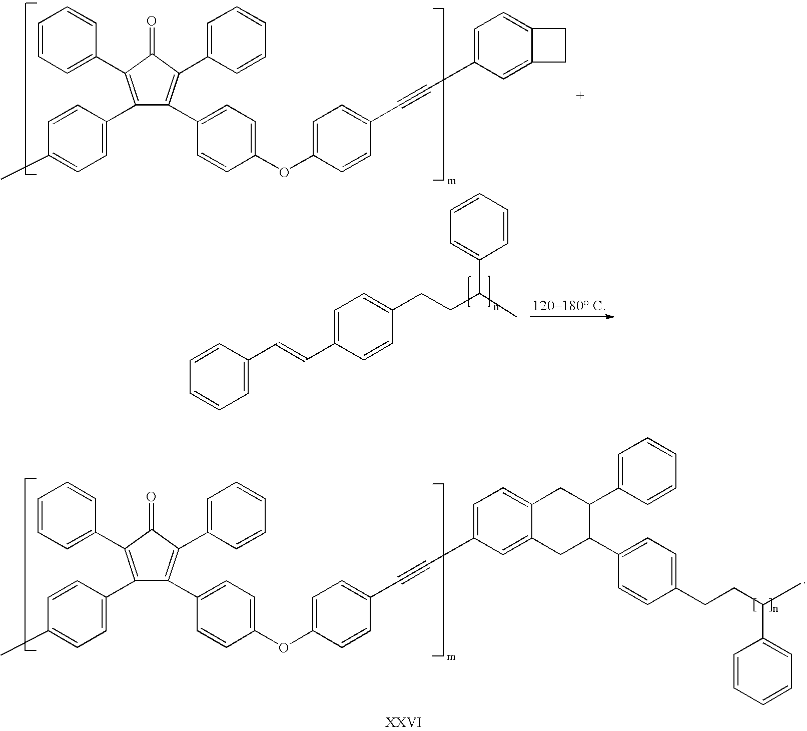

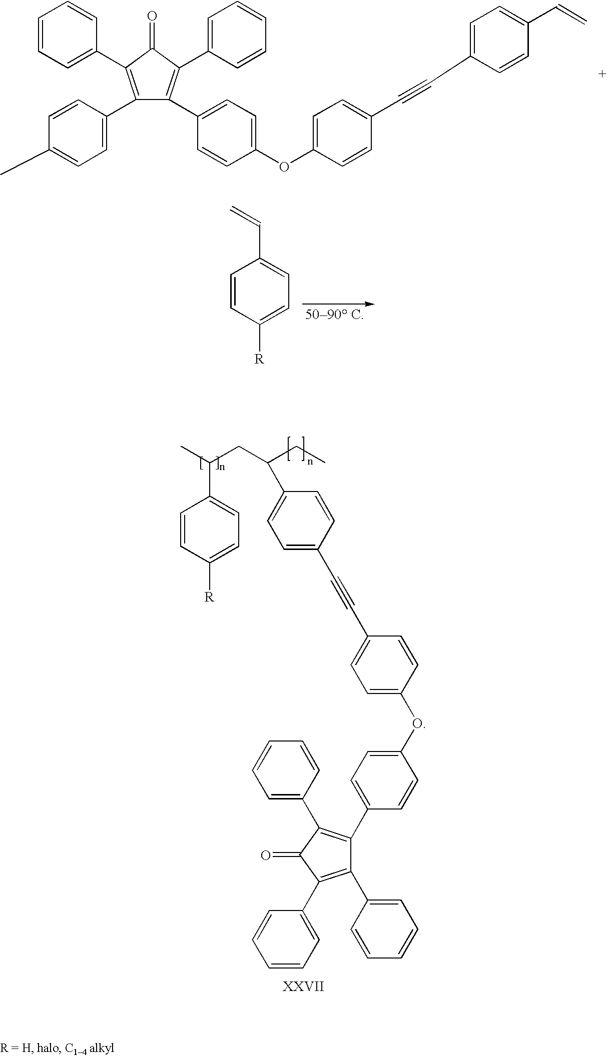

In addition, AxByC′z monomers can be used as crosslinkers during the microemulsion polymerization of vinyl monomer itself, to make crosslinked, functionalized ME? nanoparticles. Such MEP's may be further formulated with AxByC′z monomers or b-staged oligomers and introduced into the matrix by Diels-Alder reaction and ring formation or by addition polymerization, as desired Especially suitable monomers for this embodiment of the invention include compounds of formula XXVIII and XXIX.

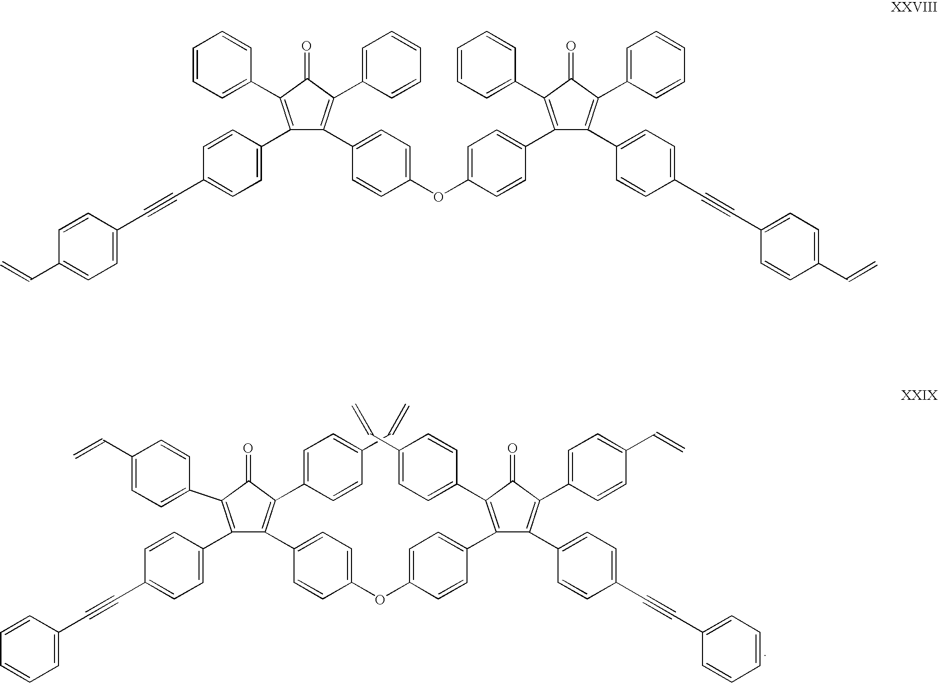

The result of incorporating bound poragens into the matrix during its formation in the foregoing manners is a near uniform correspondence of pores with initial bound poragen moieties and limited or no agglomeration and heterogeneous phase separation of the poragens. In addition, separate thermal processing for purposes of pore formation may be avoided if the decomposition temperature of the bound poragen is appropriately chosen. The resultant articles, including films or coatings, are extremely low dielectric constant, nanoporous materials having highly uniform electrical properties due to the uniformity of pore distribution.

Highly desirably, the matrix materials formed from monomers of the present invention are relatively thermally stable at temperatures of at least 300° C., preferably at least 350° C. and most preferably at least 400° C. In addition, the matrix polymer also has a Tg of greater than 300° C. and more preferably greater than 350° C. after being fully crosslinked or cured. Further desirably, the crosslinking or vitrification temperature of the invention, defined as the temperature upon heating at which flexural modulus increases most quickly, is desirably below the decomposition temperature of the poragen, preferably less than or equal to 400° C., most preferably, less than or equal to 300° C. This property allows crosslinking to take place before substantial pore formation occurs, thereby preventing collapse of the resulting porous structure. Finally, in a desirably embodiment of the invention, the flexural modulus of the partially crosslinked and cured polymer, either with or without poragen present, desirably reaches a maximum at temperatures less than or equal to 400° C., preferably less than or equal to 350° C., and most preferably, less than or equal to 300° C. and little or no flexural modulus loss occurs upon heating the fully cured matrix to a temperature above 300° C., such as may be encountered during pore formation via thermolysis.

In one suitable method of operation, AxByC′z monomer, the functionalized MEP or other poragen forming material, optional comonomer, and optional solvent are combined and heated at elevated temperature, preferably at least 160° C., more preferably at least 170° C. for at least several hours, more preferably at least 24 hours to make a solution of crosslinkable b-staged oligomers bearing bound poragens. The amount of matrix precursor or monomer, relative to the amount of poragen forming compound may be adjusted to give a cured matrix having the desired porosity. Preferably, the amount of poragen forming compound based on combined poragen and monomer weight is from 5 to 80 percent, more preferably from 20 to 70 percent, and most preferably from 30 to 60 percent.

Solutions containing monomer and poragen forming compound for use herein desirably are sufficiently dilute to result in optical clear solutions having the desired coating and application properties. Preferably, the amount of solvent employed is in the range of 50-95 percent based on total solution weight. The solution may be applied to a substrate by any suitable method such as spin coating, and then heated to remove most of the remaining solvent and leave the monomer or b-staged oligomer, containing bound poragen moieties dispersed therein. During the solvent removal process and/or during subsequent thermal processing, the poragen phase desirably forms separate uniformly dispersed occlusions within the matrix precursor or fully cured matrix. Upon continued or subsequent heating, the occlusions decompose into decomposition products that may diffuse through the cured matrix, thereby forming a porous matrix.

The concentration of pores in above porous matrix is sufficiently high to lower the dielectric constant or reflective index of the cured polymer, but sufficiently low to allow the resulting porous matrix to withstand the process steps required in the fabrication of microelectronic devices. Preferably, the quantity of pores in the resulting cross-linked porous matrix is sufficient to result in materials having a dielectric constant of less than 2.5, more preferably less than 2.0.

The average diameter of the pore is preferably less than 100 nm, more preferably less than 20 nm, and most preferably less than 10 nm. The pore sizes can be easily controlled by adjusting the size of the MEP employed in a grafting process or adjusting the quantity of addition polymerizable monomer or telegen employed in production of the bound poragen.

The compositions of the invention may be used to make dielectric films and interlayer dielectrics for integrated circuits in accordance with known processes, such as those of U.S. Pat. No. 5,965,679. To make a porous film the bound poragen is preferably removed by thermal decomposition of the poragen.

The invention is further illustrated by the following Examples that should not be regarded as limiting of the present invention. Unless stated to the contrary or conventional in the art, all parts and percents are based on weight.

### EXAMPLE 1

### Synthesis of A₂B₂C′₂ Monomer

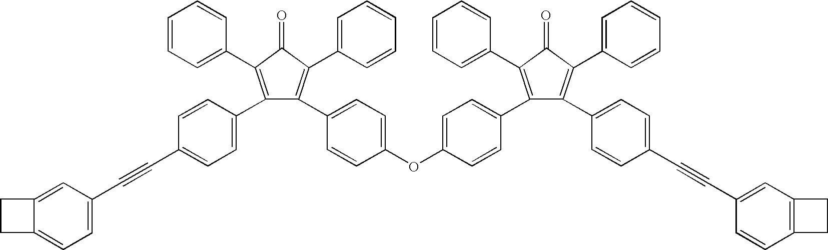

### A) Synthesis of 4-Bromophenylacetyl Chloride

4-Bromophenylacetic acid (99.5 grams, 0.46 mole) and N,N-dimethylformamide (2 milliliters) are added under a dry nitrogen atmosphere to a predried one liter glass single neck round bottom Schlenk reactor containing a predried magnetic stirring bar. After sealing under dry nitrogen, the reactor is placed on a Schlenk line under slightly positive nitrogen pressure. Thionyl chloride (300 milliliters) is added under a dry nitrogen atmosphere to a predried glass addition funnel which is outfitted with a Schlenk adaptor, then sealed under dry nitrogen and placed on the Schlenk line. The reactor and addition funnel are coupled under dynamic nitrogen flow, after which the thionyl chloride is added dropwise to the stirred reactor. Nitrogen flow is maintained into the Schlenk reactor, while gas from the reaction is vented through the Schlenk adaptor on the addition funnel and into a scrubber system. At the completion of the thionyl chloride addition, the addition funnel is replaced under dynamic nitrogen flow with a condenser capped with a Schlenk adaptor vented into the scrubber system, then a thermostatically controlled heating mantle is used to gently heat the reactor contents to 60° C. After holding for 2.5 hours at 60° C., the excess thionyl chloride is stripped from the product by applying vacuum from the Schlenk manifold. The resulting 4-bromophenylacetyl chloride product (106 grams, 98.1 percent isolated yield) is maintained under dry nitrogen until use.

### B) Synthesis of 4,4′-bis[(4-Bromophenyl)acetyl]phenyl ether

Diphenyl ether (38.6 grams, 0.227 mole), aluminum chloride (60.5 grams, 0.454 mole) and anhydrous dichloromethane (250 milliliters) are added under a dry nitrogen atmosphere to a predried one liter glass single neck round bottom Schlenk reactor containing a predried magnetic stirring bar. After sealing under dry nitrogen, the reactor is placed on a Schlenk line under slightly positive nitrogen pressure. An ice bath is then placed under the reactor. 4-Bromophenylacetyl chloride (106 grams, 0.454 mole) dissolved in dichloromethane (100 milliliters) is added under a dry nitrogen atmosphere to a predried glass addition funnel which is outfitted with a Schlenk adaptor, then sealed under dry nitrogen and placed on the Schlenk line. The reactor and addition funnel are coupled under dynamic nitrogen flow, then the 4-bromophenylacetyl chloride solution is added dropwise to the stirred reactor over a 3 hour period. After 2 hours of post reaction, the reactor is removed from the Schlenk line and the contents poured over cracked ice contained in a 4 liter beaker. After complete melting of the ice, the precipitated product is dissolved into dichloromethane (14 liters) and the water layer removed using a separatory funnel. The dichloromethane solution is washed with deionized water (2 liters), then dried over anhydrous sodium sulfate. The resulting slurry is filtered through a medium fritted glass funnel, then the dry filtrate is passed through a column of silica gel, using additional dichloromethane (2 liters) eluent, as needed. The dichloromethane solution is rotary evaporated to dryness, giving 119 grams of white powder. High pressure liquid chromatographic (HPLC) analysis reveals the presence of the desired product at 94 area percent accompanied by a single coproduct present at 6 area percent.

Recrystallization from boiling acetonitrile (14 liters) and recovery via filtration and drying in a vacuum oven gives 96.0 grams (75.0 percent isolated yield) of 4,4′-bis[(4-bromophenyl)acetyl]phenyl ether as shimmering white platelike crystals with the HPLC analysis demonstrating complete removal of the coproduct (100 area percent product). ¹H Nuclear magnetic resonance (NMR) analysis is consistent with the assigned structure of the product.

### C) Synthesis of 4,4′-bis[(4-Bromophenyl)glyoxalyl]phenyl ether

4,4′-bis[(4-Bromophenyl)acetyl]phenyl ether (44 grams, 0.078 mole) and dimethylsulfoxide (600 ml) are added to a two liter glass three neck round bottom reactor with magnetic stirring. Aqueous 48 percent hydrobromic acid (100 grams) is added with an addition funnel over three minutes. Heating to 90° C. is commenced, with the formation of a clear light orange colored solution noted once this temperature is achieved. After 3 hours at the 90° C. reaction temperature, the hot product solution is diluted into 3 liters of toluene followed by washing of the toluene solution twice with 300 ml portions of deionized water. The washed toluene solution is rotary evaporated to dryness, giving 30 grams (65 percent isolated yield) of light yellow colored powder. HPLC analysis reveals the presence of the desired product at 100 area percent. ¹H NMR analysis is consistent with the assigned structure of the product.

### D) Synthesis of 4,4′-bis[(3-benzocyclobutene-ethynylphenyl)glyoxalyl]phenyl ether

In a 200 ml flask are placed 15 grams (0.025 mole) of 4,4′-bis[(4-bromophenyl)glyoxalyl]phenyl ether, 12 grams (0.12 mole) of triethylamine, 6.65 grams (0.12 mole) of 3-benzocyclobutene-acetylene, and 60 milliters of N,N-dimethylformamide. The reaction mixture is purged with nitrogen for 15 minutes and then 0.40 gram (0.0015 mole) of triphenylphosphine and 0.05 gram (0.0002 mole) of palladium acetate are added. After heating the reaction mixture at 80° C. under nitrogen atmosphere for 3 hours, the flask is allowed to cool to room temperature, and water (200 milliliters) are added. The solid product is filtered and dissolved into 2 liters of toluene. The organic solution is washed with 10 percent aqueous HCl, water and saturated aqueous NaCl, then dried with anhydrous Na₂SO₄. The toluene solution is then passed through a silica gel filter and the pure product (16.5 grams, 96 percent isolated yield) is obtained upon removal of the toluene and recrystallization from toluene/hexanes.

### E) Synthesis of Monomer

4,4′-Bis[(3-benzocyclobutene-ethynylphenyl)glyoxalyl]phenyl ether (3.43 grams, 0.005 mole) and 1,3-diphenylacetone (2.52 grams, 0.012 mole) are added to 300 milliliters of anhydrous 1-propanol. Stirring and heating are commenced, and once the suspension reaches refluxing temperature, tetrabutylammonium hydroxide (50 percent in water, 0.5 ml) is added in three portions, immediately inducing a deep red purple color. After maintaining the reflux for 2 hours, HPLC analysis indicates that full conversion of the 4,4′-bis[(3-benzocyclobutene-ethynylphenyl)glyoxalyl]phenyl ether reactant has been achieved. At this time, the oil bath is removed from the reactor, and the reaction mixture is allowed to cool to room temperature. The product is recovered via filtration through a medium fritted glass funnel. The crystalline product on the funnel was washed with two 100 milliliter portions of 1-propanol, then dried in a vacuum oven to provide 4.0 grams (77 percent isolated yield) of monomer with greater than 90 percent purity by HPLC analysis.

### EXAMPLE 2

### Synthesis of A₂BC′₂ Monomer

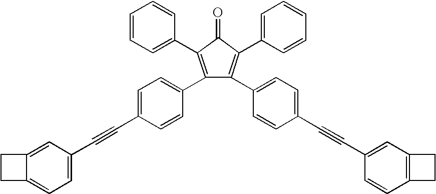

### A) Synthesis of 4,4′-Benzocyclobuteneethynylbenzil

To a 100 ml round flask are added 4,4′-dibromobenzil (3.45. g, 0.0091 mole), DMF (20 ml), 3-benzocyclobutene-acetylene (2.56 g, 0.02 mole), and triethylamine (4 g, 0.04 mole). The resulting mixture is purged with nitrogen for 15 minutes, and then triphenylphosphine (0.08 g) and palladium acetate (0.017 g) are added. The reaction mixture is heated to 80° C. for 2 hours. After cooling down to room temperature, water (100 ml) is added. The crude product is filtered and the solid redissolved into methylene chloride. Upon evaporation of the solvent, yellow crystals are obtained which are further recrystallized from methylene chloride/hexanes.

Yield 3.2 g, 76 percent.

### B) Monomer Synthesis

4,4′-Benzocyclobutene-ethynyllbenzil (1.5 grams, 3.3 mmole) and 0.85 grams (4.1 mmole) of 1-(4-phenylethynylphenyl)-3-phenyl-2-propanone are added to a reactor containing 30 milliters of anhydrous 1-propanol. Stirring and heating are commenced, and once the suspension reaches reflux temperature, tetrabutylammonium hydroxide (50 percent in water, 0.25 milliter in two portions) is added, immediately inducing a deep red purple color. After maintaining at reflux for 1.5 hours, HPLC analysis indicates that full conversion of the 4,4′-benzocyclobuteneethynyllbenzil reactant is achieved. At this time, the oil bath is removed from the reactor, and the reaction mixture is allowed to cool to 40° C. The product is recovered via filtration through a medium fritted glass funnel. The crystalline product on the funnel is washed with two 20 milliter portions of 1-propanol, then dried in a vacuum oven to provide 1.5 grams (72 percent isolated yield) of the desired A₂BC₂ monomer with greater than 98 percent purity.

### EXAMPLE 3

### Synthesis of ABC′ Monomer

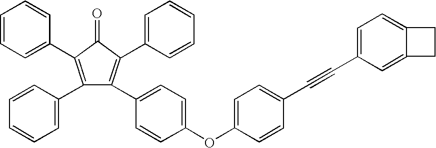

### A) Synthesis of Phenylacetyl 4-Bromophenyl Ether

To a stirred suspension of AlCl₃ (62.5 g, 0.47 mole) in CH₂Cl₂ (130 ml) at 0° C. is added dropwise, a mixture of bromodiphenylether (92.7 g, 0.37 mole) and phenylacetic chloride (63.4 g, 0.41 mole) over a period of 60 minutes. After the addition is completed, the reaction mixture is stirred at 0° C. for another 4 hours and then slowly poured into 1 liter of ice/water. The resulting product is extracted with 800 ml of toluene and dried over Na₂SO4. Upon evaporation of solvents, a yellow solid is obtained after recrystallization from 2-propanol.

Yield 122 g, 89 percent.

### B) Synthesis of phenylacetyl-4-bromophenyl Ether

Phenylacetyl 4-Bromophenyl ether (66 grams, 0.18 mole) and dimethylsulfoxide (200 ml) are added to a two liter glass three neck round bottom reactor with magnetic stirring. Aqueous 48 percent hydrobromic acid (50 grams, 0.3 mole) is added with an addition funnel over three minutes. Heating to 90° C. then commenced, with the formation of a clear light orange colored solution noted once this temperature is achieved. After 4 hours at 90° C., the hot product solution is diluted into 250 ml of toluene followed by washing of the toluene solution twice with 300 ml portions of deionized water. The washed toluene solution is rotary evaporated to dryness, and recrystallized from ethanol. Yield is 60.2 grams (88 percent) of light yellow colored powder. HPLC analysis reveals the presence of the desired product at 100 area percent. ¹H NMR analysis is consistent with the assigned structure of the product.

### C) Synthesis of 3-Benzocyclobutene-ethynylphenyl)glyoxalyl]phenyl Ether

To a 250 ml round flask is added phenylacetyl-4-bromophenyl ether (7.6 g, 0.02 mole), DMF (60 ml), benzocyclobutene-acetylene (3.2 g, 0.025 mole), and triethylamine (5.1 gg, 0.05 mole). The resulting mixture is purged with nitrogen for 15 minutes, and then triphenylphosphine (0.30 g) and palladium acetate (0.04 g) are added. The reaction mixture is heated to 80° C. for 4 hours. After cooling to room temperature, water (100 ml) is added. The crude product is filtered and the solid redissolved into toluene/hexanes. Upon evaporation of the solvent, yellow crystals are obtained which can be further recrystallized from toluene/heptane. Yield 5.5 g, 64 percent.

### D) Synthesis of ABC′ Monomer

3-Benzocyclobutene-ethynylphenyl)glyoxalyl]phenyl ether (1.1 grams, 0.0025 mole) and 1,3-diphenylacetone (0.63 grams, 0.003 mole) are added to 20 milliliters of anhydrous 1-propanol and 5 ml of toluene. Stirring and heating is commenced and once the suspension fully dissolved, phosphazene super base P₁-tBu-tris-(tetramethene) (0.3 ml) is added in several portions, immediately inducing a deep red purple color. After maintaining reflux conditions for 2 hours, HPLC analysis indicates that full conversion of the 3-benzocyclobutene-ethynylphenyl)glyoxalyl]phenyl ether reactant has been achieved. At this time, the oil bath is removed from the reactor, and the reaction mixture is allowed to cool to −20° C. The product is recovered via filtration through a medium fritted glass funnel. The crystalline product on the funnel is washed with two 20 milliliter portions of 1-propanol, then dried in a vacuum oven to provide 1.0 grams (66 percent isolated yield) of ABC′ monomer.

### EXAMPLE 4

### Preparation of Porous Matrix

To a 50 ml round flask was added 2.0 g A₂B₂C′₂ monomer from Example 1, 1.0 g crosslinked polystyrene microemulsion particles (11 nm, VSF=1.9) and 6.0 g of γ-butyrolactone (GBL). The resulting mixture is purged under nitrogen for 15 minutes and then heated to 170° C. with an oil bath under nitrogen for 7 hours. The mixture is then cooled to 145° C. and diluted with 6 g of cyclohexanone. The mixture is cooled to room temperature to give a suspension of polymer grafted microemulsion particles in GBL/cyclohexanone.

The mixture is applied to a silica wafer and cast by spin-coating to form a film having a thickness of 1.0 μm. The film is baked on a hotplate at 150° C. for 2 minutes, and then transferred to a vacuum oven. The oven temperature is ramped at 7° C./minute to 415° C. under nitrogen and held at that temperature for 40 minutes to allow the decomposition of polystyrene poragen before cooling. The resulting porous film has a pore size range from 5 to 20 nm with an average pore size of 10 nm as determined by visual analysis of a photograph obtained by transmission electron microscopy (TEM). The refractive index of the resulting film is 1.50 with a k value of 2.2.

What is claimed is:

1. A compound comprising i) one or more dienophile groups (A-functional groups), ii) one or more ring structures comprising two conjugated carbon-to-carbon double bonds and a leaving group L (B-functional groups), and iii) one or more addition polymerizable, telechelic, or graftable functional groups (C′-functional groups), characterized in that the A-functional group of one monomer is capable of reaction under cycloaddition reaction conditions with the B-functional group of a second monomer to thereby form a polymer and C′-functional groups are selected from the group consisting of benzocyclobutene, prone, ceclopentadiene, cyclopropane, and ethylenically unsaturated groups.

2. A compound according to claim 1 corresponding to the formula, 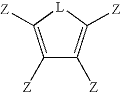
wherein L is —O—, —S—, —N═N—, —(CO)—, —(SO₂)—, or —O(CO)—;
Z is independently in each occurrence hydrogen, halogen, an unsubstituted or inertly substituted hydrocarbyl group, Z″, or two adjacent Z groups together with the carbons to which they are attached form a fused aromatic ring,
Z″ is a divalent derivative of an unsubstituted or inertly substituted hydrocarbyl group joining two or more of the foregoing structures, or joining an A-functionality, a C′-functionality and/or a combination of the foregoing,
and in at least one occurrence, Z is —Z″—C≡CR¹; or
in at least one occurrence, Z is —Z″—C≡CR² and in at least one other occurrence Z is a C′-functionality; wherein,
R¹ is independently each occurrence selected from the group consisting of groups containing C′-functionality; and
R² is independently each occurrence selected from the group consisting of hydrogen, C₁₋₄ alkyl, C₆₋₆₀ aryl, and C₇₋₆₀ inertly substituted aryl groups.

3. A compound according to claim 2 corresponding to the formula: 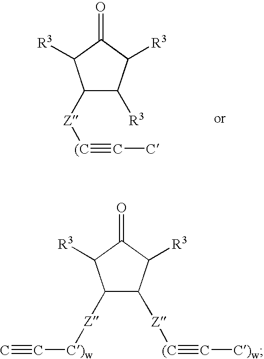
wherein R³ is C₆₋₂₀ aryl or inertly substituted aryl
w independently each occurrence is an integer from 1 to 3,
Z″ is a divalent aromatic group, and
C′ is as previously defined in claim 1.

4. A compound according to claim 1 wherein C′ functionality is independently each occurrence represented by one of the following structures:

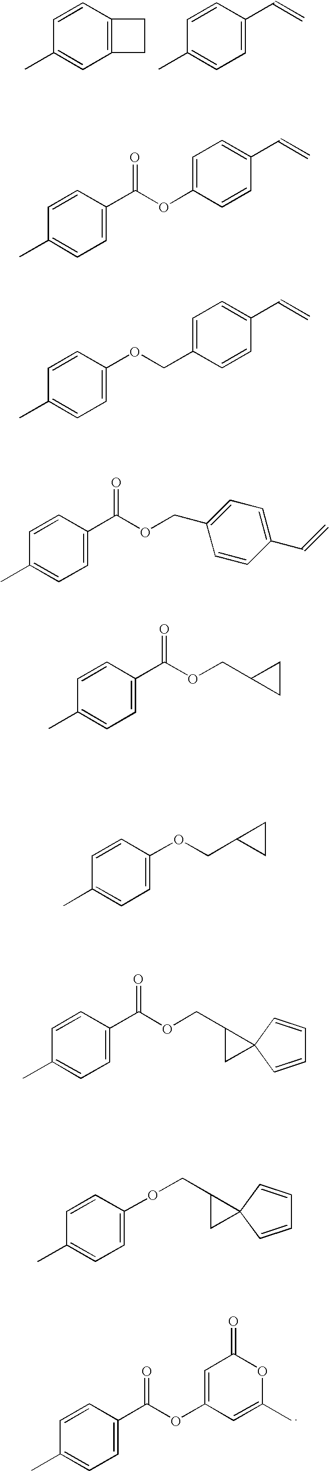

5. A compound according to claim 4 wherein the C′-functionality each occurrence is a benzocyclobutane functional group.

6. A compound according to claim 1 corresponding to the formula:

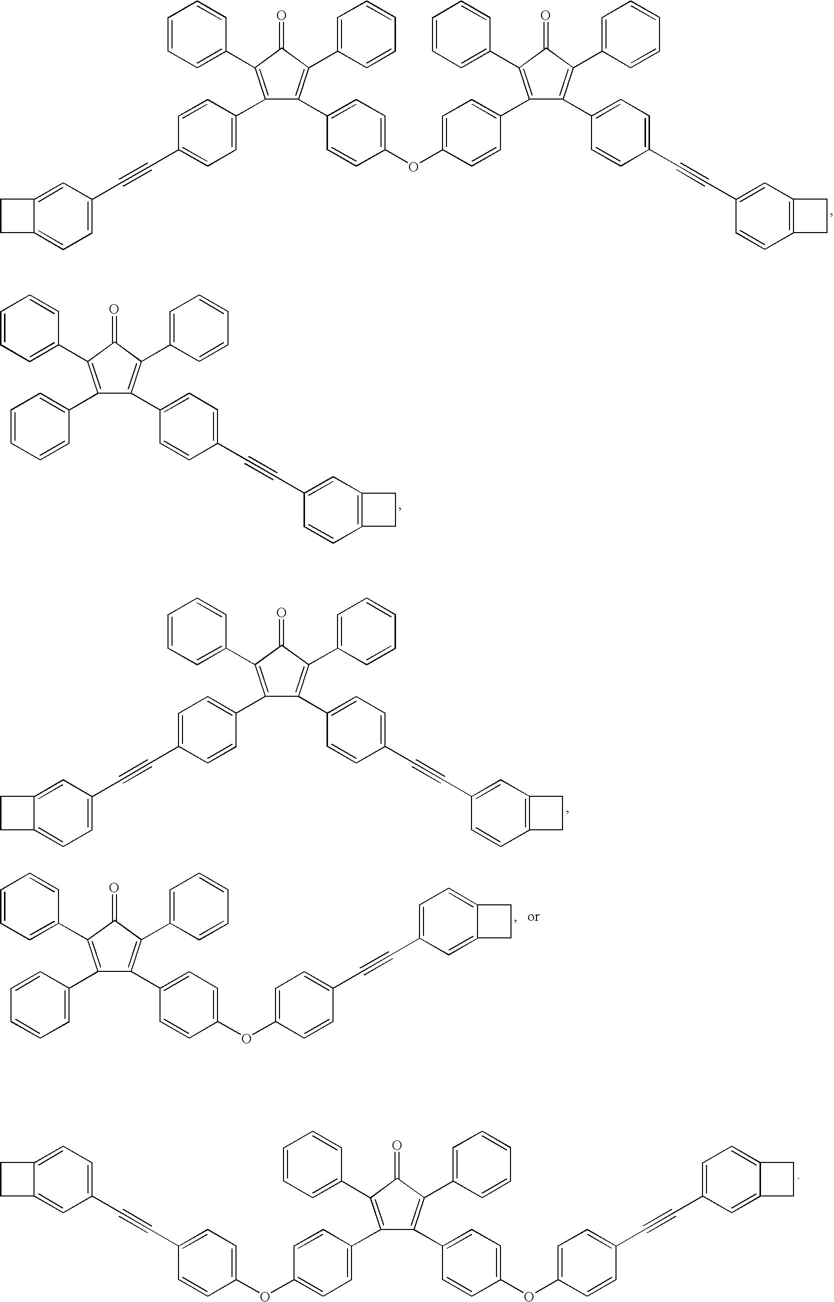

7. A cross-linked polymer formed by curing a composition comprising a compound according to any one of claims 1-6.

8. A cross-linked polymer according to claim 7 comprising a bound poragen wherein an oligomeric or polymeric moiety is chemically bound by means of C′ functionality of the compound prior to, simultaneously with, or after, cross-linking of the compound.

9. A porous matrix formed by removing the bound poragen from the cross-linked polymer of claim 8.
